(19) United States
(12) Patent Application Publication
(10) Pub. No.: US 2026/0044324 A1
(43) Pub. Date: Feb. 12, 2026

(54) AUTOMATED COMPILER AND RUNTIME SUPPORT FOR OBJECT VERSION HISTORY MAINTENANCE AND ACCESS

(71) Applicant: Zoho Corporation Private Limited, Kanchipuram District (IN)

(72) Inventors: Sridhar Vembu, Tenkasi (IN); Akshhayaa S, Guduvanchery (IN); Joseph Sathya Kumar, Chennai (IN); Raghul SenthilKumar, Coimbatore (IN); Subathra Periakaruppan, Madurai (IN); Pradeep Kumar Duraisamy Soundrapandian, Sivakasi (IN); Sudheer A. Grandhi, Pleasanton, CA (US)

(73) Assignee: Zoho Corporation Private Limited, Kanchipuram District (IN)

(21) Appl. No.: 19/293,641

(22) Filed: Aug. 7, 2025

Related U.S. Application Data
(60) Provisional application No. 63/700,695, filed on Sep. 29, 2024.

(30) Foreign Application Priority Data
Aug. 9, 2024 (IN) 202441060693

(51) Int. Cl. G06F 8/41

(52) U.S. Cl. CPC G06F 8/41

(57) ABSTRACT

Automated version history support for data entities is disclosed. A versioned query programming construct is provided that allows a developer to access a prior version of the data entity. A compiler is disclosed which automatically generates code to create and maintain version history for data entities at runtime. The version history is then available at runtime to service a query for a prior version, such as from query instructions compiled from the versioned query construct. A versioned data entity access instruction, used to access a prior version of the data entity, includes a data entity access construct modified by a versioned reference construct having a version reference. The version reference may be a time, a version number, or an event.

### CROSS REFERENCE TO RELATED APPLICATION

This application is related to Indian Provisional Application 20/244,1060693 filed 9 Aug. 2024, and U.S. Provisional Application 63/700,695, filed 29 Sep. 2024, both entitled “BUILT-IN ESCROW HISTORY MANAGEMENT FOR OBJECTS, CONTAINERS, AND CONTAINMENTS”, both incorporated herein by reference.

### FIELD OF THE INVENTION

Embodiments of the present disclosure are related, in general, to computer programming languages and more particularly, but not exclusively, to object version history.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1A depicts an example embodiment of a computational device 100 comprising a compiler 130 operable to produce executable code 160 to perform version history for objects.

FIG. 1B illustrates executable code 160 loaded into a memory 150 of computational device 100 to perform version history management at runtime.

FIG. 1C illustrates alternate embodiments of generating VHMM code for version history management.

FIG. 2 is a flowchart 200 illustrating an example embodiment of automated version history compilation.

FIG. 3 is a flowchart 300 illustrating an example embodiment of processing a modification of an entity in source code.

FIG. 4 is a flowchart 400 illustrating an example embodiment of compiling a version reference construct for a data entity.

FIGS. 5A-5C are flowcharts 500 illustrating runtime operation of an example embodiment of a version reference query engine.

FIG. 6 illustrates the five sets of time stamps, and the version history update instructions that will be generated at compilation from the instructions of Example 3.

FIG. 7 is an example embodiment of a version history 190.

FIG. 8 illustrates MMO supported runtime object creation, updating and deletion.

FIG. 9 is an example compiler 130 illustrating VHMM processing on an intermediate representation and an example version history management processing phase 940.

FIG. 10 illustrates an example embodiment of distributed IDE 1000 including components of a computational device, or user terminal, 100.

### DETAILED DESCRIPTION

Automated version history support for data entities is disclosed. In addition to conventional access to a data entity, e.g. an object, collection, etc., a versioned query programming construct is provided that allows a developer to access a prior version of the data entity. A compiler is disclosed which generates code to create and maintain version history for data entities at runtime. The code generation is automated, not requiring developer intervention. The version history is then available at runtime to service a query for a prior version, such as from query instructions compiled from the versioned query construct.

A versioned data entity access instruction, used to access a prior version of the data entity, includes a data entity access construct modified by a versioned reference construct having a version reference. A bespoke data entity access construct may be provided in a programming language embodiment. In the example embodiment, data access constructs such as assignments, function arguments, or parameters are used conventionally, with a modifier. For example, a conventional function call foo (D), where D is a data entity, will access the current version of D and with it perform function foo. With the versioned reference construct, a function call foo (D_[version reference]), where “[” and “]” delineate the versioned reference construct, and indicate that a prior version of D, specified by “version reference”, should be accessed for processing by function foo. An example compiler is configured to differentiate conventional access to the current version of a data entity and versioned access to a prior version of the data entity, and to generate instructions for both types of access accordingly. Detailed below are example embodiments, where the version reference identifies a version number, a time, and an event.

Source code containing the versioned data entity access instruction also contains a data entity definition that compiles to instantiate the data entity at runtime, as well as one or more update instructions which compile to instructions to modify the data entity at runtime. Each update to the data entity produces a prior version. Example update, or data modification, instructions include a creation of the data entity, an update to a value of the data entity, appending an entity or element to a collection within the data entity, removing an entity or element from a collection within the data entity, and deletion of the data entity. The prior versions of the data entity may be stored in and accessed from a version history. Any means for storing and accessing prior versions of the data entity may be deployed to operate with the versioned reference construct. Example embodiments are detailed below. The source code is compilable and executable by a processor and stored on a non-transitory computer-readable medium.

A method for compiling source code to automatically generate and maintain version history for one or more data entities is disclosed. The compiler identifies data entities in source code as versioned data entities and locates any dependencies of each versioned data entity. When an instruction to update a dependency is encountered, instructions are generated to capture a timestamp at runtime as the time at which the update instruction is executed and to enter one or more records including the timestamp into a version history associated with the updated dependency. Records in the version history also record modifications made as a result of the update instructions. An update instruction operating on a dependency, or part thereof, produces an updated dependency result. Any data element or data entity may be part of the dependency of a versioned data entity. An element or entity may be within the dependency of multiple versioned data elements.

A dependency may include a data element. The update instruction assigns a value to the data element, and the generated instructions enter a version history record associated with the data element containing the value. If that data element is contained in a container, the generated instructions enter a second version history record associated with the container and an identifier of the data element. An example container with data element is an object of a type having at least a first element. The update instruction may update multiple additional data elements of the container. For each of these, a pair of version history records are entered, one for the additional data element and one for the container.

A dependency may include a container containing a collection of data entities. If the update instruction creates and adds a new entity to the collection, generated instructions enter a first version history record associated with the collection identifying the new data entity and a second version history record associated with the new data entity identifying one of its elements. If an existing entity is added to the collection, a collection record is entered identifying the existing entity. A record for the existing entity need not be generated. Update instructions may combine various functions such as creating, updating, or deleting a data entity, as well as appending, inserting, or removing the data entity to or from a collection. In each case, instructions to insert the appropriate records are generated by the compiler.

All of the data entities in source code may be identified as versioned data entities and therefore have automatic version history generated for them. Subsets of data entities may be identified as versioned, perhaps based on the entity type. A list of entities to be included in or a list of entities to be excluded from versioning may be supplied to the compiler. The compiler may identify data entities for versioning based on version reference query constructs within the source code.

In an example embodiment detailed below, the generated instructions are implemented with an event handler, a version history updater, which receives event handler calls identifying the appropriate entity for a record along with the time stamp and the relevant update information, e.g. the updated dependency result.

The compiler may also generate instructions which compile to implement versioned queries at runtime. When the compiler encounters an access instruction including the versioned reference construct, detailed above, having a version reference for identifying a version of the data entity, it generates instructions to access a version history comprising one or more updates to the data entity, to form a versioned data entity by selecting one or more of the updates whose associated update times conform with the version reference, and to access the versioned data entity. The compiler can also support caching a version of a data entity that has been formed responsive to an access request, by generating instructions to store in a memory the versioned data entity and the version reference as a stored version reference identifier associated with the versioned data entity. The compiler can generate instructions to determine if a stored version reference identifier in a memory equals the version reference requested and access that stored version instead of performing the generated instructions to form the versioned entity. The compiler may optionally evaluate the source code to determine a likelihood of runtime access to a version of the data entity and generate instructions to store that version in the memory. It can generate instructions to go directly to access this version. A predetermined threshold may be used as a decision criterion in this process. Specifically, if the compiler determines that the likelihood of accessing a particular version of the data entity exceeds the threshold it will cause the version to be stored. The threshold may be a fixed value, or it may be dynamically determined based on factors such as runtime conditions, application-specific performance requirements, or resource availability.

When the version reference is a version number, the compiler generates instructions to verify at runtime that the data entity has a current version number, computed as the number of updates to the data entity, where an error is generated the version reference exceeding the current version number. When the version reference is a time, the compiler generates instructions to verify at runtime that the data entity was created before the time, and the requested time is less than current time, otherwise an error is generated. For event-based references, an error is generated if the event has not occurred or the event time is prior to the existence of the data entity.

A system supporting runtime versioned query comprises one or more processors coupled to a memory, a version history stored in the memory, and one or more programs to be executed by the processors, including a first program that records in the version history records responsive to modifications to a data entity during runtime and a second program that receives a request to access a data entity version identified by a version reference, forms a versioned data entity from version history records retrieved from the version history that conform with the version reference, and responds to the request therefrom. The system further comprises a cache in the memory in which one or more versioned data entities are stored, and wherein the version reference query engine further accesses the cache to determine whether the versioned data entity identified by the version reference is stored within it. If it is, the system retrieves the stored versioned data and responds to the request with it, in lieu of forming the versioned data entity from version history records.

A construct in a programming language refers to a particular syntactic structure or a piece of code that performs a specific task. Constructs are the basic building blocks of a program, and they can include various elements such as data types (integers, strings, etc., as well as user-defined), variables, operators, control structures (if statements, for loops, while loops, etc.), functions and procedures, classes and objects, modules and packages, and exception handling constructs. A construct may be comprised of multiple constructs, such as a block of code. Each programming language has its own set of constructs, and the way these constructs are used can vary from one language to another.

At the source code level, user-defined types pertain to structures, classes, interfaces, and other composite data types that programmers define to represent and manipulate complex data structures more effectively. These types go beyond the basic data types like int, float, and char that most languages offer inherently. In object-oriented programming, user-defined types allow for the encapsulation of data and related functionality into cohesive units referred to generally as objects. At compile time, the compiler checks these types for syntactic and semantic correctness. This includes ensuring that the members of a class or structure are correctly defined, that methods are properly declared and implemented, and that any inheritance or interface implementation is correctly specified.

A programming language provides for user defined types, which, when compiled, produce instructions for the use of objects of the defined type. Types are defined for use in instantiating objects at runtime. Objects can be affected by object management instructions compiled from object management constructs. Examples detailed herein include create, update, and delete. Create, update, and delete functionality is built into the example compiler and accessible to developers using the example programming language. These functions can be extended by a developer to customize the functionality. In one embodiment, each object management function, and optionally extension thereof, is implemented using a Memory Management Object (MMO). A runtime object management system using Memory Management Objects is detailed in U.S. Patent Application Publication 2024/0241697 A1, entitled “EXTENSIBLE BUILT-IN OBJECT MANAGEMENT”, published 18 Jul. 2024 by Sridhar Vembu and Akkshhayaa S, which is incorporated by herein by reference (hereinafter the '697 publication). Embodiments are described below illustrating various aspects.

Containers in a programming language have containments which include data entities such as elements, objects, members of other classes, collections of objects, and collections of other containers. This organization allows Container-Containment association for structured management and access of objects within a program. Example 1 depicts user code where containers and containments are arranged (zoho_projects>project>tasklist>task>name, description). In this example, multiple containers and containments are associated and organized in a nested fashion. The container task contains elements name and description, and container task is contained within the nested sequence of containers tasklist, project, and zoho_projects. The container tasklist is a containment within the nested containers project and zoho_projects. The project containment is within the zoho_projects container. Thus, an entity is treated as a container or a containment based on the point from which it is addressed. Containments can be collections, such as a collection of tasks in a task list, and multiple task lists for a project.

| | |
|---|---|
| 1 | zoho_projects := type |
| 2 | /project := type |
| 3 | |
| 4 | .zoho_projects/project |
| 5 | /tasklist := type |
| 6 | |
| 7 | .zoho_projects/project/tasklist |
| 8 | /task := type |
| 9 | name := string |
| 10 | description := string |

### Example 1. Containers and Containments

The term Computed Entity (CE) defines a type or entity of a type that is dependent on an Independent Entity (IE), which may be a user-creatable entity. A computed entity can also be derived from additional independent entities as well as from another computed entity. A computed entity can be a single variable or a collection such as a set or a sequence. The independent entity can also be a scalar or a collection. When an independent entity is updated, then prior to use, a computed entity depending on that independent entity should be updated accordingly, although different strategies such as lazy or eager updating may be deployed. Updating a scalar CE entails recomputing its value, while updating a collection may include adding a new element, recomputing one or more element values, or deleting an element from the collection.

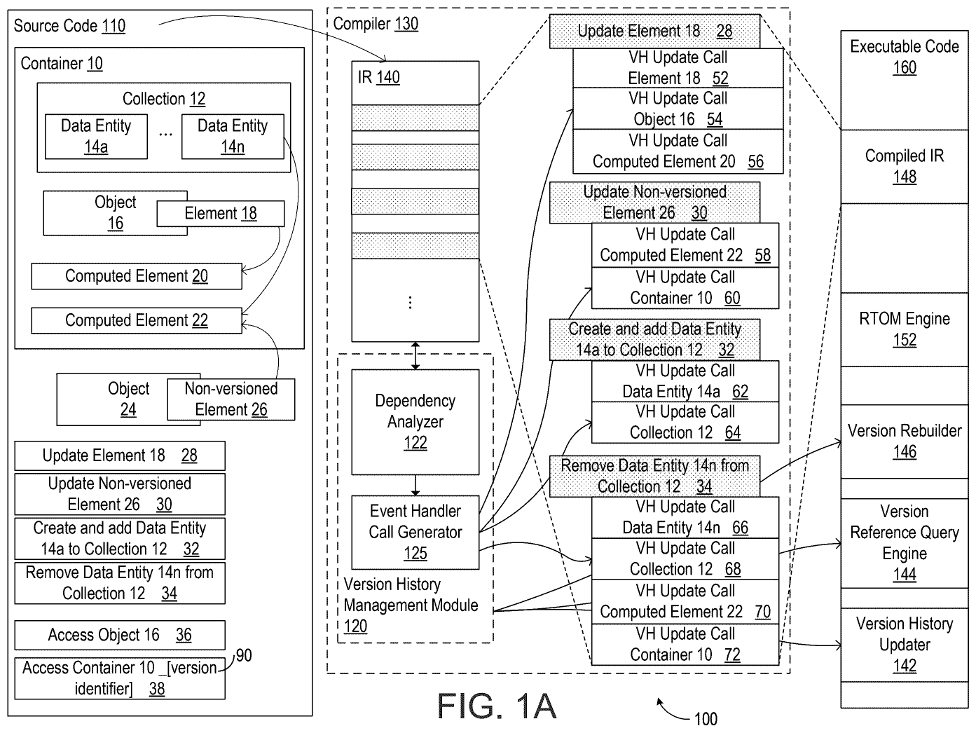

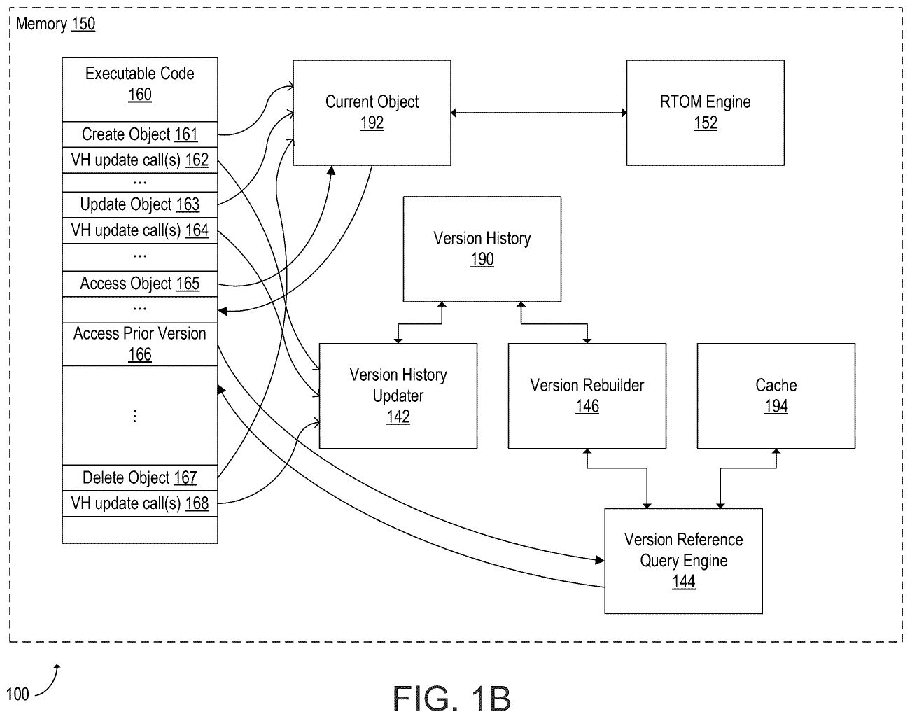

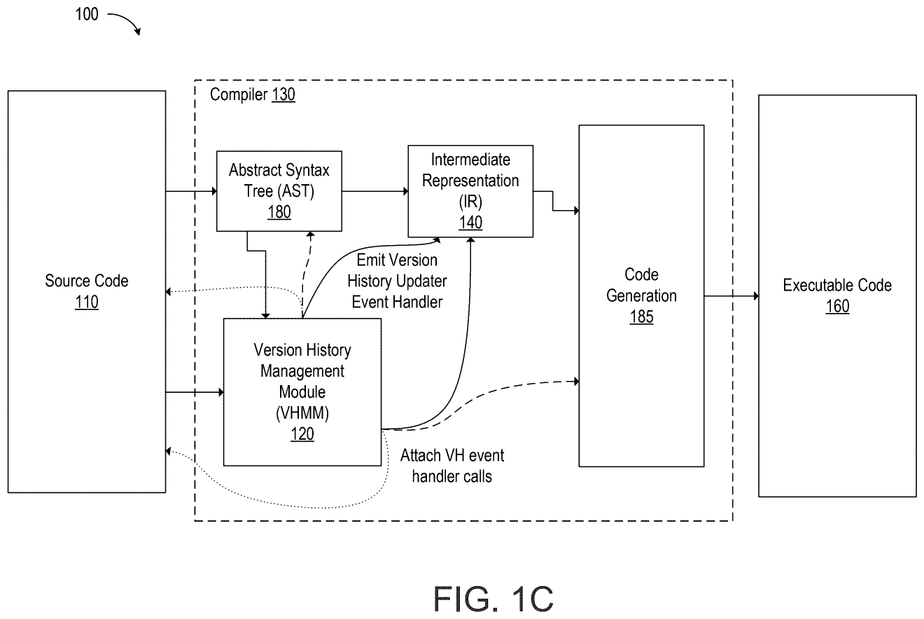

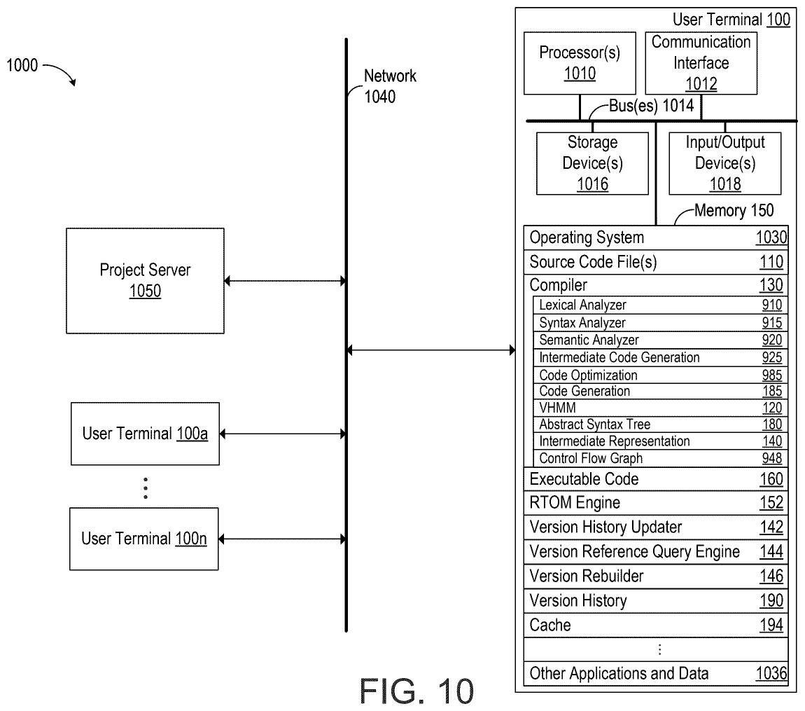

FIG. 1A depicts an example embodiment of a computational device 100, such as a computer or user terminal, detailed further below with respect to FIG. 10, which comprises a compiler 130 operable with an Intermediate Representation (IR) 140 of source code 110 to perform version history for objects. IR 140 can be further compiled to produce executable code 160. FIG. 1B illustrates executable code 160 loaded into a memory 150 of computational device 100 to perform data object management and version history management at runtime.

Compiler 130 generates intermediate representation (IR) 140 from source code 110. Version History Management Module (VHMM) 120 operates on IR 140, which can be any type of IR, and can operate on source code directly in an alternate embodiment. It identifies each versioned entity in source code. VHMM 120 auto-generates instructions for establishing and maintaining version history at runtime for each versioned data entity. A variety of embodiments are disclosed for auto-generating these instructions during compile time at differing phases of compilation. In all of those, however, with the resultant executable code, at runtime, version history is established and maintained automatically and accurately without requiring intervention in source code by a programmer. Any number of additional compiling phases may be performed on IR 140, and IR 140 may be compiled into executable code 160.

Source code 110 comprises symbolic representations of example object definitions, object management functions, and access instructions to illustrate several aspects. A container 10 comprises collection 12, object 16, and two computed properties 20 and 22. Collection 10 includes data entities 14a-n. At the end of source code 110 instructions 38 access a prior version of container 10, the version specified by version identifier 90, surrounded by “_[” and “]” which indicate the instructions call for versioned access. This is contrasted with instructions 36 which access object 16 conventionally. In this example, the versioned access of container 10 in source code indicates to compiler 130 that version history management is to be deployed for container 10. Computed entity 20 is dependent on element 18 of object 16, which, as part of versioned container 10, is also automatically versioned. This is due to the fact that the versioned access to container 10, in this illustration, retrieves any element or sub-element of container 10, so all of them are versioned. If the versioned access was more specific, e.g. only to collection 12, then other data entities incorporated in container 10 may be omitted from versioning. Compiler 130 manages this automatically.

Source code 110 also defines object 24. In this illustration, object 24 is not versioned. Computed entity 22 of container 10 is dependent on versioned and non-versioned data entities, versioned data entity 14n and non-versioned element 26 of object 24.

Several illustrative object management instructions are provided. Instructions 28 provide an update to data element 18, which is versioned. Instructions 30 provide an update to non-versioned element 26. Instructions 32 create data entity 14a and add it to collection 34.

In this example embodiment, a Runtime Object Management (RTOM) engine 152 is emitted into executable code 160. It is used for conventional object management. It also supports an embodiment of event-based version queries. In particular, detailed further below, it can coordinate Memory Management Object (MMO) events with version queries. Here, RTOM engine 152 is emitted as pre-compiled executable code. In an alternate embodiment, this engine is emitted into an intermediate representation (IR) for further compilation along with the rest of the program, or emitted as low-level language, machine code, or others.

Version history management module 120 processes IR 140. In the example embodiment, when at least one data element is versioned, version history updater 142 is emitted into executable code 160. In this example, version history updater 142 is implemented as an event handler. Various event handler calls are injected to update a version history for each versioned data element that is updated. Version history updater 142 can be inserted into IR for compilation or emitted as low-level language, machine code, or pre-compiled executable code.

A version reference query engine 144 and version rebuilder 146 are emitted into executable code 160 to processed versioned reference queries. When a required to support a versioned query to a data element, version rebuilder 146 may be called on to build the appropriate version to supply a response to the query. In some cases, the version may have been memoised and stored in memory or already present in a cache, in which case the version may not require building. Accesses to current versions of data entities are processed conventionally with RTOM engine 152. Responsive to versioned queries located in IR 140, VHMM 120 generates instructions and inserts them appropriately in IR 140 to interface with version reference query engine 144 at runtime. Examples are detailed further below. Version reference query engine 144 and version rebuilder 146 can be inserted into IR for compilation or emitted as low-level language, machine code, or pre-compiled executable code.

Version history update calls for the illustrative object management instructions are generated by VHMM 120 and inserted into IR 140. Each object management function encountered during compilation is processed by VHMM 120. If the object management function is applied to a versioned data entity, or to a non-versioned data entity on which a versioned data entity is dependent, then appropriate event handler calls will be generated by event handler call generator 125. Dependency analyzer 122 is used to determine which data entities may need to trigger version history updates (VH update calls) in response to an object management function. In one embodiment, IR 140 is converted into a Control Flow Graph (CFG) (another form of IR) for further analysis. From the CFG, the dependencies of objects based on their container containment association are identified, as well as any other type of dependency. Event handler calls are used for version history updating in the example embodiment. Alternate schemes may also be used.

The instructions 28 to update element 18 will be determined to affect a versioned data entity. Here, the element 18 itself will be updated, and that update will be reflected in object 16 in which it resides. In this case, event handler call generator 125 will create and insert into IR 140 the appropriate calls to update the version history responsive to the update instructions. VH update call 52 stores the version history for element 18. VH update call 54 stores the version history for object 16. Note that instructions 28 to update element 18 use RTOM engine 152 to perform the object management function conventionally on object 16. Computed entity 20 is also dependent on data element 18 in this example. VH update call 56 is generated to store version history for computed entity 22.

The compiler may take into consideration a variety of factors when auto-generating version history. For example, when an update is called on an element on which a computed entity depends, there may be several strategies to choose from. If versioned accesses were not being supported, the compiler could choose to implement cager or lazy updating of the computed entity, where eager always recomputes immediately and lazy waits for an access to the computed entity. With versioned accesses, it won't necessarily be known whether or not an access to a prior version of the computed entity will be made. So, the compiler may a) always compute and store the updated computed entity (eager), or b) ensure that the required data to make the computation are versioned allowing for the computation of a computed entity version only when requested (lazy). The compiler may also discern that only a subset of versions of an object will ever be or possibly be accessed. In which case it can simply cause those versions to be memoised and omit event handlers which record all future updates. For example, it is known that only the object at creation and one year later are ever queried. There may be other reasons to prevent storage. For example, regulatory requirements may prevent certain types of sensitive data from being archived.

Instructions 30 to update non-versioned element 26 operate conventionally. As the data entity is not versioned, there is no need to update the version history, and no VH update calls for element 26 are generated. However, dependency analyzer 122 has identified computed entity 22, a versioned data entity, as dependent on element 26. As such, VH update call 58 is generated to store version history for computed entity 22. VH update call 60 is also generated to store version history for container 10, responsive to the update to contained computed entity 22.

Instructions 32 create data entity 14a and add that data entity to collection 12. Each of these is versioned, as they are contained in versioned container 10. VH update call 62 is generated to store version history for the creation of data element 14a. VH update call 64 is generated to store version history for collection 12, responsive to the addition of data entity 14a to the collection.

Instructions 34 remove data entity 14n from collection 12. VH update call 66 is generated to store version history for data entity 14n. Note that in this example, a version history record is stored for data entity 14n for illustrative purposes. This presumes that data entity 14n is “aware” that it was in the collection, and now no longer is. In an alternate embodiment, the data entity 14n is not aware it is in a collection, and therefore no record of its removal needs to be recorded (e.g. VH update call 66). In some embodiments, this information may be stored in the version history for debugging purposes, as the form of versioned access to entity 14n in certain embodiments does not provide any information about which collections entity 14n finds itself included. The following records are recorded in any event. VH update call 68 is generated to store version history for collection 12, responsive to the removal of the data element from the collection. Computed entity 22 is dependent on data element 14n in this example. As before, VH update call 70 is generated to store version history for computed entity 22. VH update call 72 is generated to store version history for container 10, responsive to the update to contained computed entity 22 and collection 12.

FIG. 1B depicts IR 140 having been compiled into executable code 160 and loaded into a memory 150 for runtime execution. Example instructions are included to illustrate version history management and query at runtime. The components emitted by VHMM 120 are also shown. Compile and runtime environment 100 may be implemented on a computer such as a user terminal detailed below in FIG. 10. Shown together here for convenience only, it is not necessary to have the runtime environment and compile environment on the same device. Compiled executable programs can be distributed for executing in any number of implemented runtime environments. At runtime, memory 150 is loaded with executable programs, such as program executable 160, RTOM engine 152, version history updater 142, version rebuilder 146, and version reference query engine 144. Other programs such as a memory management system and other operating system functions are not shown.

The layout of memory 150 is illustrative only. Executable code can be loaded in any portion of memory, contiguously or otherwise, in similar order to the stored executable, or rearranged, or in any other configuration. The same is true for objects and other runtime data. It is common practice for instructions to be stored in a stack, and object data to be stored in a heap, but any memory management technique may be employed.

Program execution encounters a create object instruction 161 calling for instantiation of an object 192. When an object management instruction is encountered at runtime, RTOM engine 152 is invoked to perform the object management function in association with a memory management system (not shown). The object, referred to as current object 192 to distinguish it from a prior version, is then created and in memory 150 as shown. In this example, object 192 is versioned, so the compiler will have introduced instructions that compile to update the version history responsive to the create instructions. In this embodiment, event handler calls to the version history updater 142 are introduced at the appropriate locations, as detailed previously. As such, VH update calls 162 interface with version history updater 142 to enter the version history records in version history 190. A new entry will be made for object 192 in version history 190. There are many schemes for storing update information for use in recreating object versions, and one example embodiment is detailed below.

After continued execution, the program encounters update object instruction 163, which, in concert with RTOM engine 152, introduces the update to object 192. VH update calls 164 are then executed to introduce the version history information to version history 190 for object 192. Any number of updates to object 192 may occur, along with creation and updating of other versioned objects, all with appropriate VH update event handler calls.

The program then encounters a conventional access object instruction 165 which retrieves information from object 192. As this instruction does not update the object, there is no call to version history updater 142. Conventional reads and writes to object 192 are made directly to it, in concert with RTOM engine.

By contrast, when an access instruction 166 for a prior version of object 192 is encountered, the access is made to version reference query engine 144. In an embodiment, a cache 194 may be implemented in memory 150 to store prior versions that have been re-built or have been otherwise indicated by the compiler to be retained in the cache. Versions may be memoised, their requests hashed and associated with the version for storing and retrieval from a hash table. Version reference query engine, responsive to the access instruction 166, looks for the version in a cache 194 if one is existing. If it is not found, a call to version rebuilder 146 is made to access records from version history 190 to rebuild the queried version. Version reference query engine 144 manages the query requests, to determine the time of the version for use in selecting records with appropriate timestamps and performs error-checking on version requests. Example embodiments are detailed further below.

In this illustration, the program then encounters delete object instruction 167 which, with RTOM engine 152, causes the deletion of object 192. Appropriate VH update calls 168 to version history updater 142 make the changes to version history 190 for object 192 responsive to its deletion.

FIGS. 1A and 1B illustrated VHMM 120 generating version history instructions and inserting those instructions in an intermediate representation. FIG. 1C illustrates alternate embodiments of generating VHMM code for version history management in computational device 100. As in FIG. 1A, compiler 130 comprising VHMM module 120 scans source code 110 for versioned entities, determines dependencies, and manages updates that affect versioned entities. In these embodiments, the instructions for managing versioned entities are generated in the form of event handlers (e.g. version history updater 142), and calls to those event handlers. Placing the calls to the event handlers in the code at differing locations determined in accordance with the object management functions causes the appropriate version history management to be executed at runtime. A first embodiment is shown identified by solid lines, where VHMM 120 emits VH event handlers into IR 140. IR 140 may be further processed as necessary and ultimately processed by code generation unit to provide executable code 160. Note that code generation may be carried out in multiple phases. For example, a low-level language such as c/llvm may be an intermediate target of code generation 185. An intermediate level compilation can be further processed into executable code for one or more target processors and/or architectures.

It is typical in a compiler for an Abstract Syntax Tree (AST) 180 to be generated from source code 110 and used for analysis and other compiling functions. In one embodiment, event handlers are emitted in AST format for each versioned entity and stitched to AST 180. AST 180 may be converted into another form of Intermediate Representation (IR) 140. Note that AST 180 is itself a form of IR, and IR 140 is not required to be a different format. A variety of additional compilation processes may be carried out on IR 140, until it is ready for code generation. Instructions to call event handlers for each computed entity are then attached to IR 140 before code generation module 185 generates executable code 160. The emission of event handlers and attachment of calls to them are illustrated by dashed lines in FIG. 1C.

Yet another embodiment is illustrated by the dotted lines in FIG. 1C. Here, the event handlers and calls can be generated in the source code language used in source code 110 and inserted into source code 110. The updated source code can then be compiled in ordinary fashion, and the version history management will be implemented automatically. Note also that the phase of code analysis need not match the phase of generated code insertion. E.g., analysis may be performed on AST 180, or source code 110 directly, or any other phase of IR 140. Any number of other embodiments may be deployed where VHMM instructions are generated in any compiler phase or code format. The description herein for compiler 130 support of VHMM is provided illustratively. It will be appreciated that it may be implemented in alternate ways over any of various phases and passes of compilation, using the principles described herein.

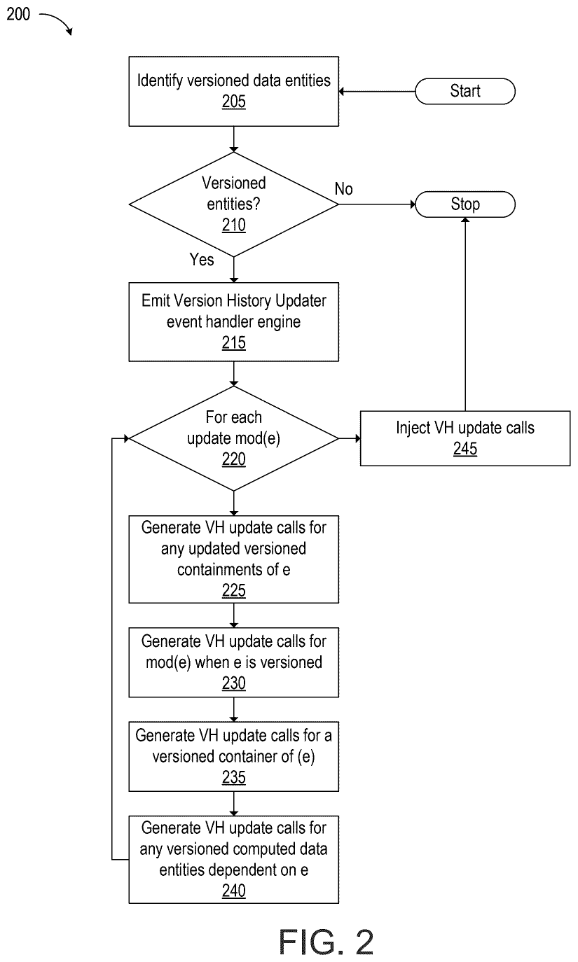

FIG. 2 is a flowchart 200 illustrating an example embodiment of automated version history compilation. The process begins by identifying versioned entities in the source code (205). A variety of tests may be deployed to determine which entities should have version history generated for them. In one example, all entities may have version history generated. In another, the source code is scanned to find references, accesses, or queries to a version of a data entity, or potential accesses. Those entities with an access or potential access are identified as versioned entities. Any other technique may be used, such as the user providing a list of entities to version, or a list of entities to exclude. The lists may be based on entity types. If the source code has no versioned entities (210) the process terminates.

In one embodiment, a developer is given control over whether data entities should maintain version history by specifying this behavior through dedicated syntax, construct, or annotations in the source code. An example of such an instruction in the source code is shown below:

$$find\_version ( of \text{::} string , at \text{::} date\_time ) = task\_list \{ \}$$

$$( task\_list \cdot name == of ) \_ [ at ]$$

In the above example, “find_version” is a function that retrieves a specific version of a “task_list” entity. The parameter “of” represents the name of the “task_list” object to be retrieved, and “at” specifies the timestamp (as a “date_time”) at which the desired version should be retrieved. The expression “task_list { }” specifies the path to the target data source. The condition “(task_list.name==of)” filters the query to select the entity instance whose name matches the value of “of”. Finally, the “_[at]” syntax instructs the compiler to fetch the version of the entity as it existed at the specified timestamp.

If there are one or more versioned entities, the compiler will emit a version history updater (215) into the code. In one embodiment, the version history updater is an event handler designed to receive calls to add records to a history for one or more data entities. It can be emitted in any form: source code, intermediate representation, byte code, or machine executable code. In subsequent steps, calls to the event handler (VH update calls) are generated and introduced into code at appropriate locations to produce a version history record responsive to an update or modification to a data entity when compiled and executed at runtime. An update or modification is a general term to include data or object management functions including create, update, or delete of a data entity, or append, insert, or remove an entity or object from a collection. In general, any instruction which would cause assignment of a value to a data entity can be used to trigger generation of a version history record for the data entity. Again, the calls can be introduced at any phase of compilation including source code, intermediate representation, or lower-level code.

The compiler loops through all updates in source code, mod (c) (220). When an update is encountered for e, the compiler checks for any updates to versioned containments of e (225). Event handler calls are generated for those containments. When the entity e is versioned, calls for the mod (e) are also generated (230).

The compiler also looks for dependencies on the data entity e being updated. If there are any data entities such as computed properties, behavioral properties, or other elements which depend on e, and those properties or elements are to be versioned, then VH update calls are generated for those computed elements (240). Note that these calls are generated whether or not e is versioned, as the relevant enquiry is the versioning of the dependent data entity.

As illustrated in various examples below, an update may include modifications to multiple elements or entities. At runtime, the processing of the various modifications, while appearing concurrent in the logic of source code, may often be performed at different system times, typically sequentially, although parallelism may also be utilized. The compiler will manage the collection of an appropriate time stamp for each set of modifications associated with a concurrent update, there actual system times notwithstanding. All of the VH update calls responsive to updates to data elements and their dependencies, when versioned, are injected into the code at appropriate locations (245). Then the process terminates.

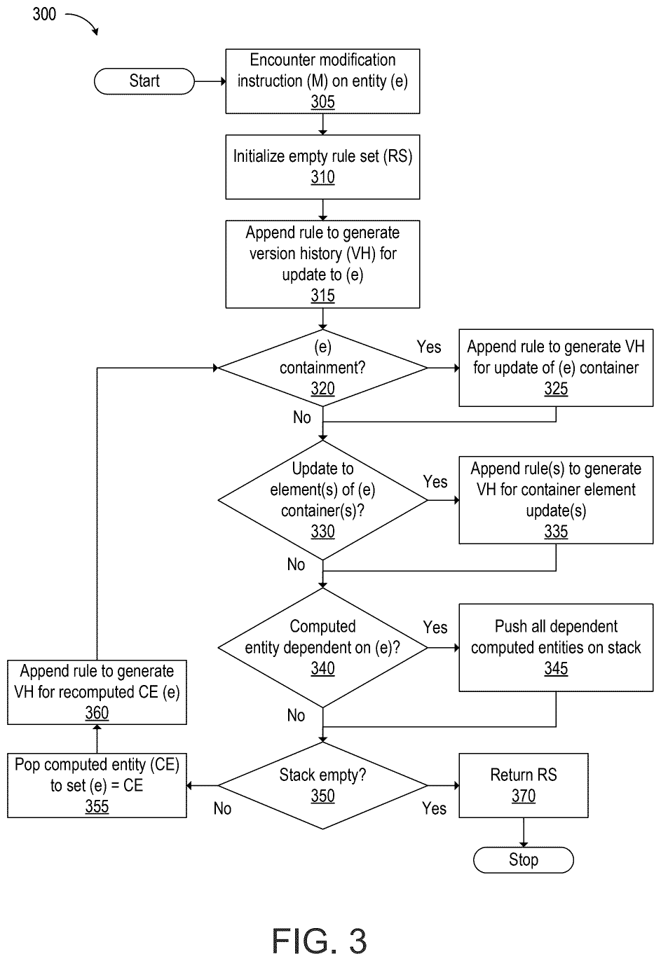

FIG. 3 is a flowchart 300 illustrating an example embodiment of processing a modification of an entity in source code. While compiling, a modification instruction M is encountered acting on an entity, which is set to e (305). A ruleset (RS) will be generated in response to the encountered entity modification, from which instructions to create and update version history records for data entities will be generated. The generated instructions may be in the form of calls to an event handler, as described above, but alternative techniques may be employed in alternate embodiments. The elements and entities described in this example are presumed to be versioned. In an alternate embodiment, adding a rule to RS may be conditional on being versioned. As described above, computed entity dependencies are checked whether or not an entity is versioned, in case the dependent entity is versioned, and its value or state will potentially be affected by the modification M to entity e. The ruleset RS is set initially to an empty set (310).

A rule to generate version history (VH) for the update to e is appended to RS (315). If e is a containment (320), then a rule to generated VH for e's container is appended to RS (325). In either case, if there are updates to an element or elements in one or more of e's containers (330), then append a rule or rules to generate VH for those container element updates (335). Then dependencies will be evaluated. If there are any computed entities dependent on e (340), then push references to each of those dependencies on a stack (345). If there are no dependencies, then the stack will be empty (350), and RS will be returned (370). If the stack is not empty, then each dependency will be evaluated in the same fashion. Pop a reference to a computed entity from the stack and set e to that computed entity (350). A rule to generate version history (VH) for the update to e (now a computed entity of the formerly evaluated entity) is appended to RS (360). Evaluation of containers, containments, and dependencies (steps 320-350) are repeated for the popped CE, which may include adding additional entities to the stack. The process continues recursively until all dependencies, and their containers, containments and dependencies, have been processed. When the stack is empty again, the ruleset RS is returned (370).

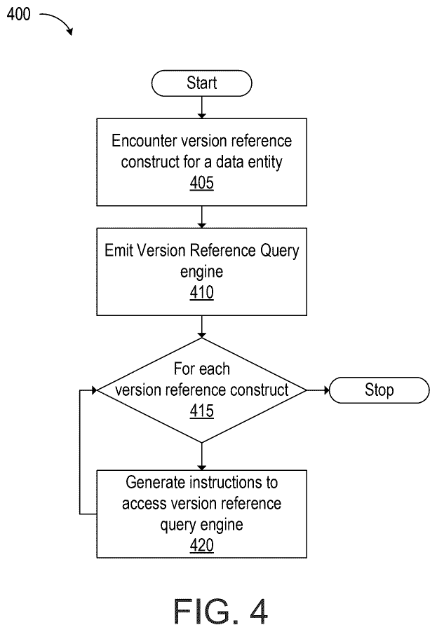

FIG. 4 is a flowchart 400 illustrating an example embodiment of compiling a version reference construct for a data entity. A version reference construct is encountered in source code during a compilation phase (405). The compiler emits a version reference query engine (410). The version reference query engine may be emitted in any form: source code, intermediate representation, byte code, or machine executable code. If the source code does not contain any versioned access to data entities, then the version reference query engine may be omitted from the resultant program executable. For each version reference construct in source code (415), generate instructions to access the version query engine (420).

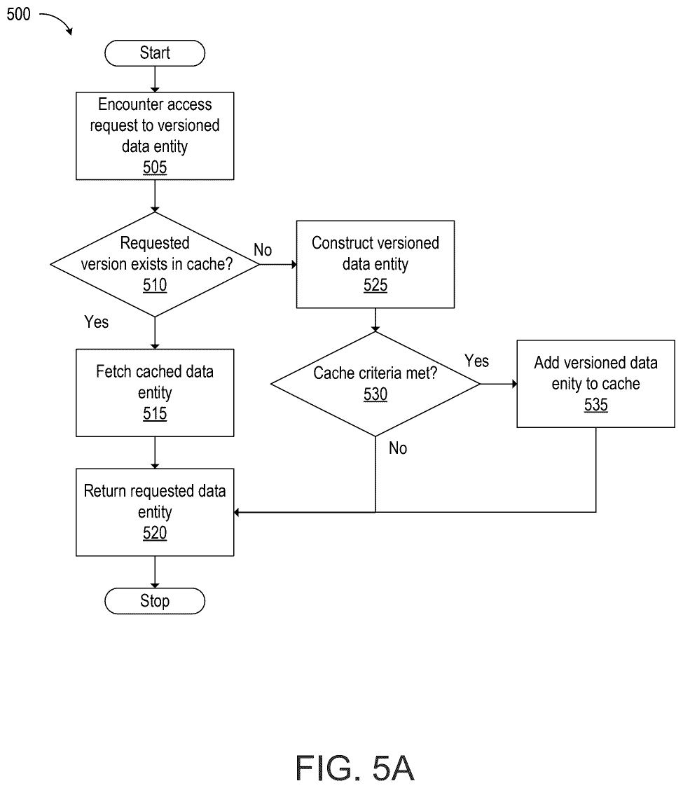

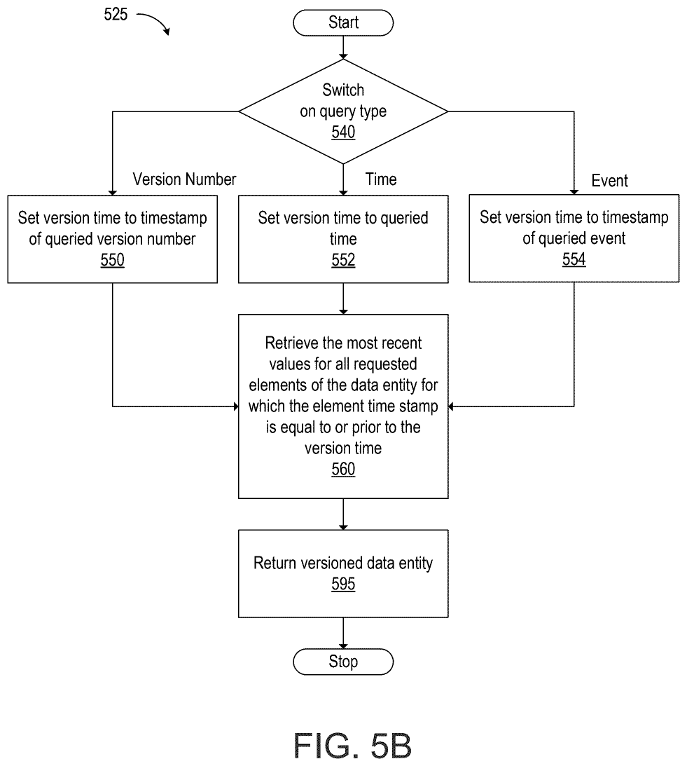

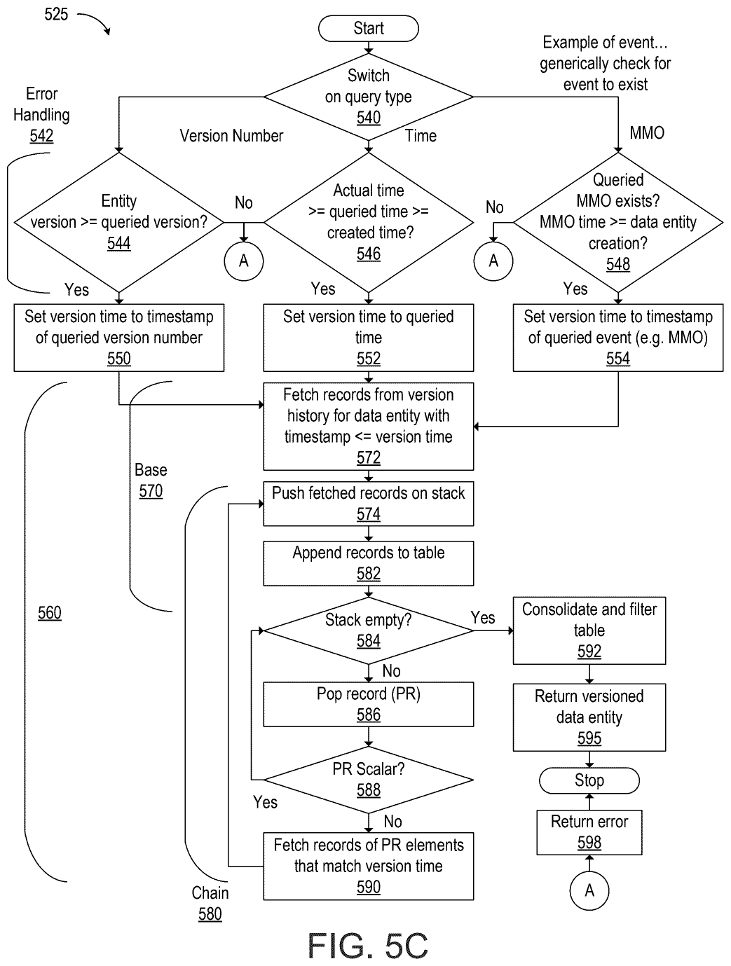

FIGS. 5A-5C are flowcharts 500 illustrating runtime operation of an example embodiment of a version reference query engine. In FIG. 5A, when an access request to a versioned data entity is encountered (505), determine whether the data entity version being requested is resident in a cache (510). If so, then fetch the cached data entity (515), and return the requested data entity version (520). The request for a version of a data entity may include a request for a scalar element or a container, an object, a collection, a data structure in general, or any element or set of elements contained therein. If the requested version is not in the cache (525) then construct the versioned data entity (525). A set of one or more criteria may be designed into the version reference query engine to indicate when a versioned data entity should be included in the cache. These criteria may evaluate usage patterns during runtime. Certain versions or entities may be recognizable by a compiler during compile time as higher frequency requests and so may be identified to the query engine to include in the cache, once constructed. Various other alternative criteria may be employed. When the criteria is satisfied for the constructed versioned data entity (530), then it will be added to the cache (535). In either case, the requested data entity is returned (520).

FIG. 5B is a flowchart illustrating an example embodiment of constructing a versioned data entity (525). In this embodiment, a query may be for a version number, or for a version at a particular time, or for a version correlated with an event, and the process switches on the query type (540). When a version number query is received, a version time is set to the timestamp of the queried version number (550). When a time query is received, the version time is set to the time included in the query (552). When an event query is received, set the version time to the timestamp of the queried event (554). Then retrieve the most recent values for all requested elements of the data entity for which the element time stamp is equal to or prior to the version time (560). The data entity elements may be retrieved from a version history as detailed herein, or any other data entity history storage, in an alternate embodiment. Once the requested elements corresponding to the version of the data entity are assembled, the versioned data entity is returned (595). The versioned data entity may be a complete data entity, such as container or object, but need not be. The instructions generated during compilation may be drawn to retrieving a subset of elements when, for example, the compiler determines access to only a subset of a versioned object is accessed based on source code evaluation.

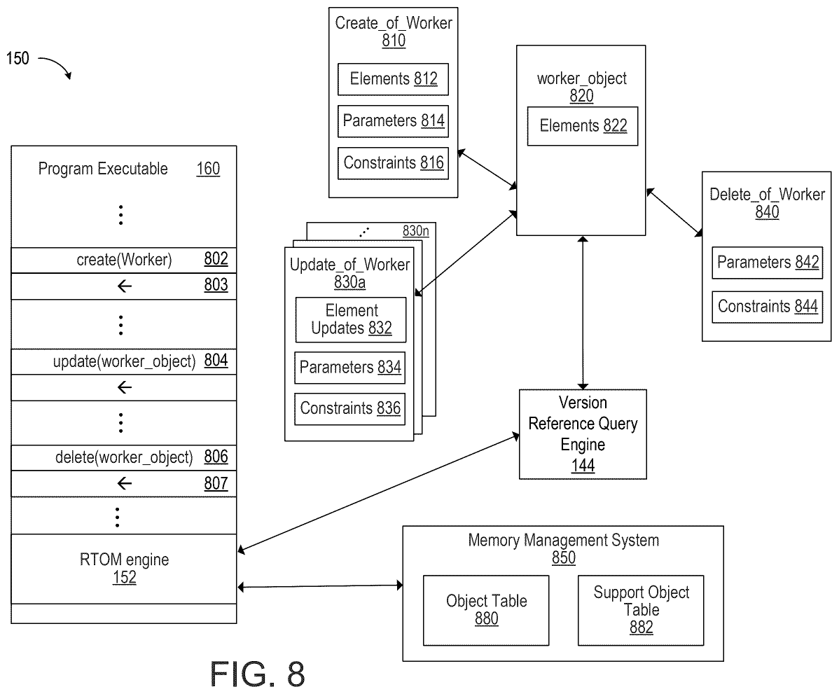

FIG. 5C is a flowchart illustrating another example embodiment of constructing a versioned data entity (525). This embodiment is similar to that of FIG. 5B, where like steps of the process have like numbers, with additional features illustrated. As before, switch on query type (540). The options here are, as before, version number and time, but, in this example, the event query chosen is for a Memory Management Object (MMO) event. An example embodiment of a runtime object management engine 152 interacting with a memory management system 850 to support object management with MMOs is detailed further below with respect to FIG. 8. Other event queries may be supported in alternate embodiments.

Here a level of error handling (542) is introduced before setting the version time for the various query types. For version number queries, check for whether the current version of the requested entity is equal to or greater than the queried version (544). If not, then the request is for a version that does not yet exist, so an error is returned (598). When valid, the version time is set to the timestamp of the queried version number (550).

For time queries, check whether the actual system time is greater than or equal to the queried time, as well as whether the queried time is greater than or equal to the time the entity was created (546). If not, the requested time is invalid for the being for the future, or for too far in the past, when the entity does not exist. In either case an error is returned (598). When valid, the version time is set to the queried time (552).

For MMO queries, check whether the queried MMO exists. If so, verify that the MMO event time is greater than or equal to the creation time of the requested entity (548). If either the MMO does not exist, or the MMO event time is before the creation time of the data entity for which a version is requested, then the query is invalid, and an error is returned (598). When valid, the version time is set to the time of the queried event, in this case the MMO timestamp (554).

Step 560, as before, retrieves the most recent values for all requested elements of the data entity for which the element time stamp is equal to or prior to the version time. In this example, that process uses a base step 570 to retrieve records for the requested data entity and then to recursively chain step 580 for all containments of the requested data entity.

Base step 570 begins with fetching records from version history for the data entity with timestamp less than or equal to the version time (572). For a version query this will be from record 1 to the requested version number. The retrieved records are pushed on a stack (574) and appended to a table (582). At this point all the relevant potential elements from the data entity are stored in the table, and the stack includes records to examine for containments in the chaining step (580).

The chaining step begins checking if the stack is empty (584). It will initially contain the record or records loaded in the base step (570). A record is popped from the stack (586). If the popped record (PR) is a scalar (588), then no further records need to be retrieved. Return to 584 to check if the stack is empty, and, if not, pop the next record. If PR is not a scalar, then fetch the records of PR elements that match (earlier or equal to) the version time (590). Return to 574 and push the fetched records on the stack and append them to the table (582). The chaining process continues in this fashion until the stack is empty.

When the stack is empty (584), then all potential records in the data element and any of its containments are included in the table. The table is then filtered and consolidated (592) until the remaining records contain the elements of the versioned data entity, which is returned (595). Other techniques for constructing a versioned entity may be deployed in alternate embodiments. Other optimizations may be deployed as well. For example, for a scalar element, it is not necessary to start at the creation time and fetch every update. The last update will suffice. For collections and sets, a version history record indicate the update, which may be a change in an element in the set or may have an element appended or removed. In an alternate embodiment, for sets, the chaining process can be performed in reverse order, and if an element has been removed, that record need not be pushed on the stack, and can be noted so that the corresponding earlier addition of the element can also be ignored. Those of skill in the art will readily adapt these and other modifications.

| | |
|---|---|
| 1 | /task_list := type |
| 2 | unique(name := string) |
| 3 | team_name := string |
| 4 | /task := type |
| 5 | unique(name := string) |
| 6 | optional(assigned_to := name) |

### Example 2. User Code to Illustrate Versioning

Example 2 is example user code to illustrate versioning. Consider a task_list type consisting of two properties “name” and “team name” along with a “task” type. Both task_list and task are sets, as indicated by the “/” preceding them. The task set consist of two properties “name” and optional property “assigned_to.” An optional property does not require a value to be assigned at the creation of the object. The “name” property in task_list and task set is marked unique, which allows objects to be identified and selected with those properties.

| | |
|---|---|
| 1 | tl1 :+task_list(name : “Supporting Version History”, team_name : |
| | “Development”) |
| | ... |
| 2 | tl1 : task_list(name : “Supporting Version History”) |
| 3 | tl1.−+name : “Supporting Versioned Queries” |
| | ... |
| 4 | tl1 : task_list(name : “Supporting Versioned Queries”) |
| 5 | tl1.+task(name : “Feature Design”, assigned_to : “Joseph”) |
| | ... |
| 6 | tl1 : task_list(name : “Supporting Versioned Queries”) |
| 7 | tl1.+task(name : “Central Version Table”) |
| | ... |
| 8 | tl1 : task_list(name : “Supporting Versioned Queries”) |
| 9 | t2 : tl1.task(name : “Central Version Table”) |
| 10 | t2.+assigned_to : “Akshhayaa” |

### Example 3. User Code to Illustrate Versioning

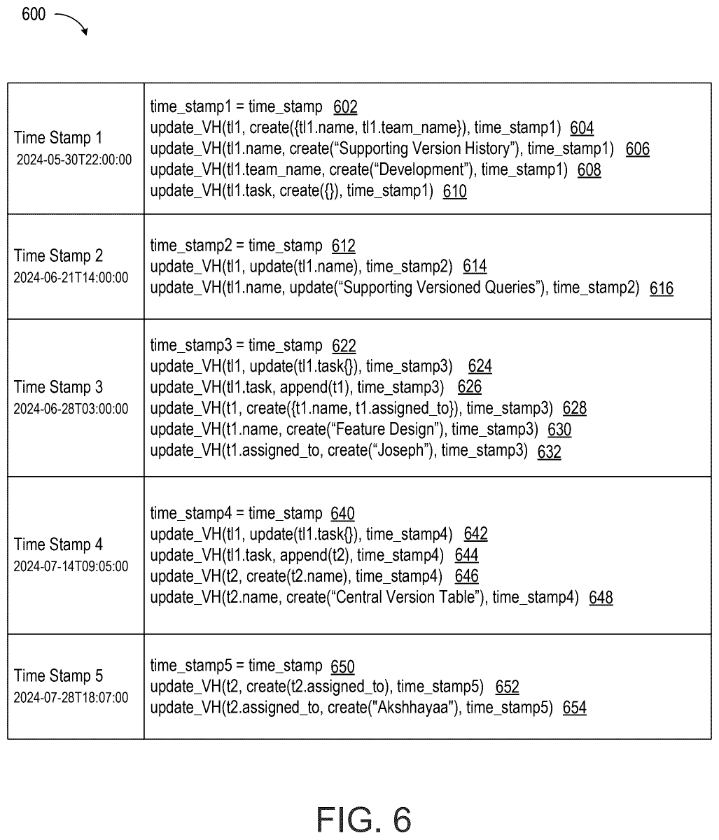

Example 3 includes additional code to illustrate creation of and updates to various objects and elements. In line 8, a task_list object tl1 is created with definitions for elements name (“Supporting Version History”) and team_name (“Development”). In this embodiment, the set/task can include the empty set, so no definition is required at creation. If there are no tasks defined at creation,/task is initialized as the empty set. Line 9 sets tl1 to the task_list of module versioning_sample with the unique name “Supporting Version History”. The name of that task_list is updated in line 10 to “Supporting Versioned Queries”. In line 11, the use of unique name “Supporting Versioned Queries” is illustrated once more to select the desired task list object as tl1. In line 12 tl1 is updated to include a new task which is created with name “Feature Design” and assigned_to “Joseph”. The task will be referred below as t1 for convenience, but it can be referenced in source code without a specific name by using the unique identifier element “name”. Line 13 again links tl1 to the appropriate task list, and line 14 tl1 is updated to include another new task, referred to later as t2, with name “Central Version Table”. The assigned_to element, which is optional, is undefined at this time. Finally, tl1 is updated once more, identified by name in line 13, with t2 identified by name in line 16, such that t2 element assigned_to is set to “Akshhayaa”. Ellipses between the sets of lines indicate that other source code is present, and that the various updates just detailed will occur at runtime at different times, in this example at five different times, as illustrated in FIG. 6.

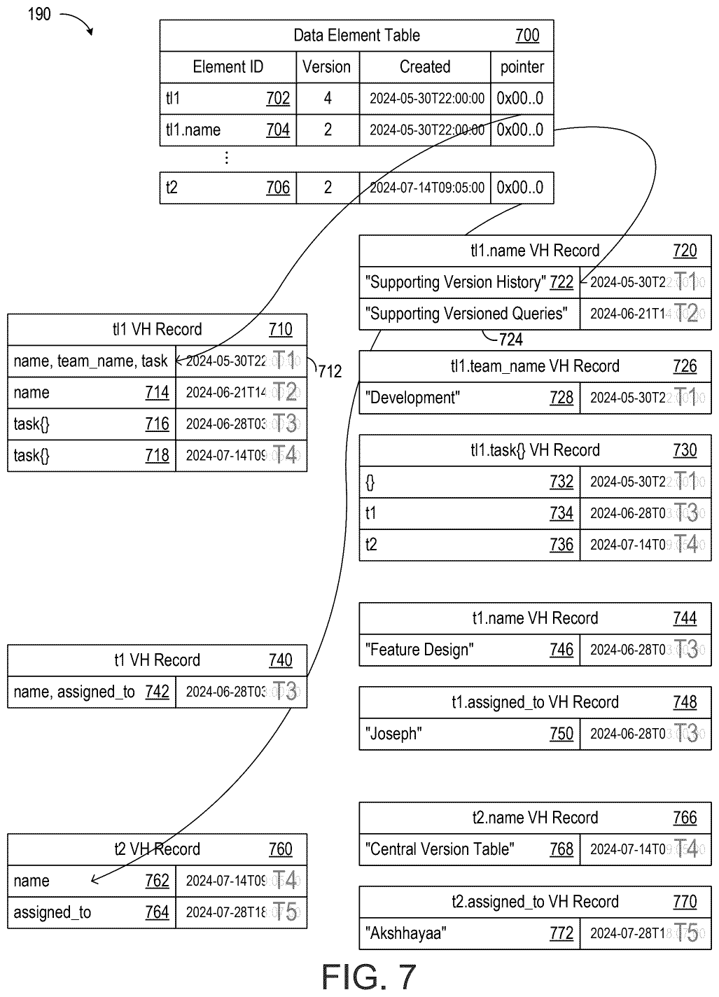

FIG. 6 illustrates the five sets of time stamps, and the version history update instructions that will be generated at compilation from the instructions of Example 3. Although the instructions are shown in pseudocode, it will be understood that the runtime instructions will be carried out in executable code (although an interpreter example acting on source code could also be deployed). FIG. 7 shows the results of these illustrative version history update instructions in an example version history 190 generated at runtime. While delete operations are not illustrated in this example, those of skill in the art will recognize the principles detailed herein apply to delete modifications as well. Note further that in this illustration, a single version history is maintained including records for multiple data entities. In various embodiments, any number of version histories may be maintained, ranging from a single version history to a version history for each data entity, and any subset in between, e.g. a version history for a container and its containment.

During compilation, when the compiler encounters the update to tl1 in line 8, it produces the following version history management instructions. The system time is captured via function time_stamp and stored as time_stamp1 (602). As in earlier examples, there is an event handler defined, update_VH, for which the compiler can generate calls to update the version history tailored for each data element update in the source code. The first call 604 indicates that tl1 has been created with elements name and team_name at time_stamp1. The second call 606 indicates that tl1.name has been created with value “Supporting Version History” at time_stamp1. The third call 608 indicates that tl1.team_name has been created with value “Development” at time_stamp. As there is no explicit creation of the set/task, it will be initialized as the empty set. The fourth call 610 indicates the tl1.task has been created empty at time_stampt1 (note that in an alternate embodiment this is optional, as an empty set may be inferred if no tasks have been supplied).

When the compiler encounters the update to tl1 in line 10, it produces the following version history management instructions. The system time is captured via function time_stamp and stored as time_stamp2 (612). The first call 614 indicates that tl1 has been updated with element tl1.name at time_stamp2. The second call 614 indicates that tl1.name has been updated with value “Supporting Versioned Queries” at time_stamp2.

When the compiler encounters the addition of a new task to tl1 in line 12, it produces the following version history management instructions. The system time is captured via function time_stamp and stored as time_stamp3 (622). The first call 624 indicates that tl1 has been updated with tl1.task { } at time_stamp3. The second call 626 indicates that tl1.task has had task t1 appended at time_stamp3. The task id t1 is a compiler generated name, since, as described above, there is no requirement to produce the identifier by the user in source code. The third call 628 indicates that task t1 has been created with elements name and assigned_to at time_stamp3. The fourth call 630 indicates that t1.name has been created with value “Feature Design” at time_stamp3. The fifth call 632 indicates that t1.assigned_to has been created with value “Joseph” at time_stamp3.

When the compiler encounters the addition of a second new task to tl1 in line 12, it produces the following version history management instructions. The system time is captured via function time_stamp and stored as time_stamp4 (640). The first call 642 indicates that tl1 has been updated with tl1.task { } at time_stamp4. The second call 644 indicates that tl1.task has had task t2 appended at time_stamp4. The third call 646 indicates that task t2 has been created with t2.name at time_stamp4. The fourth call 648 indicates that t2.name has been created with value “Central Version Table” at time_stamp4.

When the compiler encounters the update to the second new task in line 17, it produces the following version history management instructions. The system time is captured via function time_stamp and stored as time_stamp5 (650). The first call 652 indicates that t2 has been updated with the creation of t2.assigned_to at time_stamp5. The second call 654 indicates that t2.assigned_to has been created with value “Akshhayaa” at time_stamp5.

FIG. 7 is an example embodiment of a version history 190. It has a data element table 700 used to locate version history records for created data entities and elements. When an event handler call to create a data entity version history is encountered at runtime, an entry is added to the data element table with the data element identification and a pointer to the version history record. In this embodiment, the creation time stamp is also included in the data element table along with a version number (which is set to 1 on creation) to facilitate error checking when recreating a version of a data object or element. When an event handler call to update a data entity's version history is encountered at runtime, the version number is incremented accordingly. Each version history record includes the element or elements updated and the time recorded for the change. In FIG. 7, the time values are overlaid with a gray time reference, T1-T5, for case of illustration in the examples detailed below.

The example shown in FIG. 7 includes the results of the event handler calls of FIG. 6 in a runtime example. At T1 (2024-05-30T22:00:00), in response to call 604, tl1 VH record 710 is created, with a corresponding entry 702 for tl1 in data element table 700 incorporating a pointer to the version history record. The first entry 712 is recorded, which indicates name, team_name, and task were created at the time stamp recorded (T1: 2024-05-30T22:00:00). VH records 720, 726, and 730 are similarly created for tl1.name, tl1.team_name, and tl1.task, responsive to calls 606, 608, and 610, respectively, and data element table entries are made for each. Entry 704 for tl1.name is shown for illustration. The first entry 722 in VH record 720 shows that tl1.name was created at T1 (2024-05-30T22:00:00) with value “Supporting Version History”. The first entry 728 in VH record 726 shows that tl1.name was created at T1 (2024-05-30T22:00:00) with value “Development”. The first entry 732 in VH record 730 shows that tl1.task was created at T1 (2024-05-30T22:00:00) with an empty set.

At T2 (2024-06-21T14:00:00), in response to call 614, tl1 VH record 710 is updated, with a corresponding update of its version number in data element table 700 (from 1 to 2). The second entry 714 is recorded, which indicates name was updated at the time stamp recorded (T2: 2024-06-21T14:00:00). VH record 720 is updated for tl1.name responsive to call 616, and its version number is increased from 1 to 2 in table 700. The second entry 724 in VH record 720 shows that tl1.name was updated at T2 (2024-06-21T14:00:00) with value “Supporting Versioned Queries”.

At T3 (2024-06-28T03:00:00), in response to call 624, tl1 VH record 710 is updated, with a corresponding update of its version number in data element table 700 (from 2 to 3). The third entry 716 is recorded, which indicates task { } was updated at the time stamp recorded (T3: 2024-06-28T03:00:00). VH record 730 is updated for tl1.task { }, with a corresponding update of its version number in data element table 700 (from 1 to 2). Responsive to call 626, the entry 734 in VH record 730 shows that task t1 was appended to task { } at T3 (2024-06-28T03:00:00).

In response to call 628, t1 VH record 740 is created, with a corresponding entry in data element table 700. The first entry 742 is recorded, which indicates name and assigned_to were created at the time stamp recorded (T3: 2024-06-28T03:00:00). Responsive to calls 630 and 632, VH records 744 and 748 are created for t1.name and t1.assigned_to, respectively, and data element table entries are made for each. The first entry 746 in VH record 744 shows that t1.name was created at T3 (2024-06-28T03:00:00) with value “Feature Design”. The first entry 750 in VH record 748 shows that t1.assigned_to was created at T3 (2024-06-28T03:00:00) with value “Joseph”.

At T4 (2024-07-14T09:05:00), in response to call 642, tl1 VH record 710 is updated, with a corresponding update of its version number in data element table 700 (from 3 to 4). The fourth entry 718 is recorded, which indicates task { } was updated at the time stamp recorded (T4: 2024-07-14T09:05:00). VH record 730 is updated for tl1.task { }, with a corresponding update of its version number in data element table 700 (from 2 to 3). Responsive to call 644, the entry 736 in VH record 730 shows that task t2 was appended to task { } at T4 (2024-07-14T09:05:00).

In response to call 646, t2 VH record 766 is created, with a corresponding entry in data element table 700. The first entry 762 is recorded, which indicates name was created at the time stamp recorded (T4: 2024-07-14T09:05:00). Responsive to call 648, record 766 is created for t2.name, and a data element table entry is made for it. The first entry 768 in VH record 766 shows that t2.name was created at T4 (2024-07-14T09:05:00) with value “Central Version Table”.

At T5 (2024-07-28T18:07:00), in response to call 652, t2 VH record 760 is updated, with a corresponding update of its version number in data element table 700 (from 1 to 2). The second entry 764 is recorded, which indicates optional element assigned_to was recorded at the time stamp recorded (T5: 2024-07-28T18:07:00). Responsive to call 654, VH record 770 is created for t2.assigned_to, and a data element table entry is made for it. The first entry 772 in VH record 770 shows that t2.assigned_to was created at T5 (2024-07-28T18:07:00) with value “Akshhayaa”.

The following examples use the version history of FIG. 7 to illustrate various types of versioned object querying/access. For these examples, the lines shown emulate a terminal, in which a prompt in the form of the versioned access construct is entered, and a response is returned identified by “>>”. Assume that the code compiled to create this program used one or more of the embodiments detailed above.

| | |
|---|---|
| 1 | tl1_[2] |
| 2 | >>task_list |
| 3 | name : “Supporting Versioned Queries” |
| 4 | team_name : “Development” |
| 5 | task{ } : { } |
| 6 | |
| 7 | tl1.name_[1] |
| 8 | >>“Supporting Version History” |
| 9 | |
| 10 | t1_[1] |
| 11 | >>Error: Invalid Version Number for this object |

### Example 4. Version-Based Queries

Example 4 illustrates version-based queries. In this embodiment, the convention is that the version number specifies the number of versions earlier to the present version. So, at line 1, a query tl1_[2] is a request for the version of task_list tl1 two versions prior to the current version. In reviewing version history 190 illustrated in FIG. 7, it can be seem that the current version of tl1 is 4. Therefore the query is for version 2 of tl1, which was generated at time T2. The first version (at T1) had the creation of the task list with its name, team_name, and set of tasks, task (712). At T2, the name is changed (714). The result then is displayed in lines 2-5. The type identifier task_list is displayed on line 2. Then, the updated name for tl1, “Supporting Versioned Queries” is displayed on line 3, which was retrieved from entry 724. The original team_name (line 4) and task { } (line 5) are displayed, in accordance with entries 728 and 732, respectively.

A second query (line 7) asks for the prior version (version number of 1) of the name of the same tasklist, tl1.name_[1]. The current version number of tl1 is seen to be 2, so the query should return version 1. The first version of this element was recorded at T1 and is found in entry 722. The name at that time was “Supporting Version History” (line 8).

A third query (line 10) asks for the prior version of task t1, t1_[1]. It can be seen that the current version of t1 is 1. There is no prior version, so an error is displayed in line 11.

| | |
|---|---|
| 1 | tl1_[timestamp5] // tl1_[2024-07-28T18:07:00] |
| 2 | >>task_list |
| 3 | name : “Supporting Versioned Queries” |
| 4 | team_name : “Development” |
| 5 | task{ } : {t1, t2} |
| 6 | |
| 7 | tl1_[timestamp3.5] // tl1_[2024-07-07T22:05:00] |
| 8 | >>task_list |
| 9 | name : “Supporting Versioned Queries” |
| 10 | team_name : “Development” |
| 11 | task{ } : {t1} |
| 12 | |
| 13 | t2_[time_stamp5.5] // t2_[2024-08-09T22:05:00] |
| 14 | >>task |
| 15 | name : “Central Version Table” |
| 16 | assigned_to : “Akshhayaa” |
| 17 | |
| 18 | t2_[time_stamp4.5] // t2_[2024-07-21T22:05:00] |
| 19 | >>task |
| 20 | name : “Central Version Table” |
| 21 | |
| 22 | t2_[time_stamp3.5] // t2_[2024-07-07T22:05:00] |
| 23 | >>Error: Invalid Timestamp for this object |

### Example 5. Time-based Queries

Example 5 illustrates time-based queries. In this example, the times are inserted into the query with a variable name indicating a time, e.g. timestamp5, timestamp3.5, and so forth. For the illustration, the actual time represented by the variable is shown after the “//”. It is assumed that all the queries are made for times in the past, as a query for a future version would result in an error in this embodiment. So, timestamp 5 is dated 28 July as shown in line 1, and therefore tl1_[timestamp5] is processed as a query for tl1_[2024-07-28T18:07:00]. From FIG. 7, this date is past the last update of tl1 at time T4, so that version is returned (lines 2-5). The result is the latest elements, including the updated name (724) replacing the previous name (722), the original team_name (728), and all the additions to task { }, t1 (734) and t2 (736), resulting in {t1, t2}.

A second query on line 7, tl1_[timestamp3.5], requests the version of task list tl1 at the timestamp shown on 7 July, which is in between time stamps T3 and T4. As seen in record 710, team_name updated upon creation at time T1, name was updated at T2, and task { } was updated at T3. Records, 726, 724, and 734 contain the respective values current at the requested version time. The second update to task { } identified in 718 is ignored, thus task is returned as {t1} rather than {t1, t2} in the first query. The results for the second query are shown in lines 8-10.

A third query in line 13, t2_[time_stamp5.5], requests the version of task t2 at time_stamp5.5, on 9 August. This is the most recent version of the task, having been updated at time T5, 28 July. The results, lines 14-16, show the name as created (record 766) and the assigned_to element added (record 770).

A fourth query in line 18, t2_[time_stamp4.5], requests the version of task t2 at time_stamp4.5, on 21 July. This query requires the prior version of the task requested in the third query. The results, lines 18-20, like in the prior query, show the name as created (record 766) but omits the assigned_to element which was added later.

The fifth query in line 22, t2_[time_stamp3.5], requests a version of task t2 on 7 July, which is prior to its creation on 14 July, so an error is reported on Line 23.

| | |
|---|---|
| 1 | tl1_[@create] |
| 2 | >>task_list |
| 3 | name : “Supporting Version History” |
| 4 | team_name : “Development” |
| 5 | task{ } : { } |
| 6 | |
| 7 | t1_[@create(t2)] |
| 8 | >>task |
| 9 | name : “Feature Design” |
| 10 | assigned_to : “Joseph” |
| 11 | |
| 12 | t2_[@update[1]] |
| 13 | >>task |
| 14 | name : “Central Version Table” |
| 15 | assigned_to : “Akshhayaa” |
| 16 | |
| 17 | t1_[@update[1]] |
| 18 | >>Error: Invalid MMO version for this object |

### Example 6. Event-based Queries

Example 6 illustrates event-based queries. Memory management functions are one example of events that can be used as version references, and MMOs, as detailed further below, are one example implementation. For event-based query in general, any means for associating a time with an event can be used. The query in line 1 requests the version of task list tl1 at its creation, as indicated by @create. Since there is no modifier on the @create event, the compiler knows that the reference is to creation of tl1. The elements available at creation of tl1 are shown in record 710. The values for these elements are retrieved from records 722, 728, and 732, and the results are displayed in lines 2-5.

The query in line 7, t1_[@create (t2)], illustrates using an event involving a second entity, t2, as a version reference for a first entity, t1. The version of t1 existing when t2 was created is requested. Here, t2 was created at time T4. At that time, t1 exists, having been created earlier at T3. The relevant values are retrieved (records 746 and 750) and displayed in lines 7-10.

The query in line 12, t2_[@update [1]], illustrates using a specific update to an entity as an event for a version reference. The modifier indicates which update is to be used to determine the version reference time. In this case, “1” signifies the first update to t2 (since there is no reference to another entity), as illustrated in line 7. Note that a specific update to another entity is also supported. By convention, in this embodiment, the index to the update starts at 1, meaning the first update following creation. Creation is itself an update, although here it is not treated as such, given that @create can be used. In an alternate embodiment, update [0] could substitute for @create. The first update to t2 occurred at T5, which also happens to be the current version. The results in lines 12-15 are retrieved from records 768 and 772.

A query with the same syntax, but addressed to task t1, is shown in line 17. Here, however, there has been no update to t1 since it was created, so the event update [1] for t1 does not exist. As the version reference is undefined, an error message is generated, line 18.

FIG. 8 illustrates MMO supported runtime object creation, updating and deletion, as described in the aforementioned '697 publication. Memory 150 has program executable 160 (including create message 802, create trigger 803, update message 804, update trigger 805, delete message 806, and delete trigger 807), RTOM engine 152, and memory management system 850, including object table 880 as well as a support object table 882. The instructions for creating, updating, and deleting data objects (such as type worker) as well as for creating, updating, and deleting support objects (Create_of_Worker, Update_of_Worker, and Delete_of_Worker) are incorporated into RTOM engine 152. There are initially no objects in memory 160.

In addition to compiling the constructs from source code 110, the compiler emits runtime object management engine 152, introduced above. Based on the object management extensibility implementation, type definitions 202, and object management constructs 204, the compiler emits supporting functionality to implement object management instructions 232, as extended, utilizing RTOM engine 152. In one embodiment, messages create support objects utilized in affecting an object defined by a type definition 202. In an alternate embodiment, RTOM engine 152 is configurable to receive object management function calls with optional parameter extensions, and to perform constraint evaluation prior to completion of the object management functionality. Example techniques include adding an extensibility flag to identify additional parameters or a constraint. A pointer or other reference to a subroutine or function call to evaluate compiled constraints for managing an object may be provided via OM support instructions 238. Example embodiments are detailed further below.

In the example programming language create, update, and delete are referred to as messages to the compiler to perform object creation, updating and deletion respectively. Carrying out an object management function at runtime occurs in two or more steps. In the first step, the message is generated which identifies the function to perform and the arguments needed for that function and type. The message can be constructed in more than one step, updating or changing values in the message each time. When the function is to be invoked, a trigger construct, <-in the example embodiment, indicates that the message is ready to be deployed to affect the object at runtime. The code snippet in Example 7 illustrates the general functionality.

| | |
|---|---|
| 1 | ## Example messages. Use <- to trigger the message to affect the |
| | object |
| 2 | create(‘TypeName’, element: initial_value, ...) |
| 3 | object.element.update(new_value_for_element) |
| 4 | object.delete |
| 5 | object <- create(‘TypeName’, element: initial_value, ...) |
| 6 | <- object.element.update(new_value_for_element) |
| 7 | <- object.delete |

### Example 7. MMO Message and Trigger

Here lines 2-4 illustrate code syntax for messages to create, update, and delete an object, respectively. Line 2 is a create message which identifies the type name, ‘TypeName’, which is an immutable scalar corresponding to a type, of the object to be created. It also accepts a listing of data elements and initial values of those elements. Line 3 illustrates an update message, including the object identifier for updating, object, and any elements for updating, element in this example, and a new value for the element being updated. Line 4 illustrates a delete message. It can simply identify the object for deletion.

In all these examples, at runtime, a message is generated in response to instructions compiled from these message constructs, but no object management will occur until a trigger instruction activating them is encountered. Lines 5-7 illustrate the same messages with the trigger included. In the example embodiment, messages generate support objects. The support object for a message is used to affect the object at runtime when a trigger instruction is encountered. The RTOM engine 152 is used to generate the support objects, and to use those objects to affect the target object, in response to an object management instruction 232, as guided and assisted by the object management support instructions 238.

In one embodiment, illustrated in further detail in the following figures, object management functions are accessed with messages, embodied object as management support objects, or MMOs, in the example, which include all necessary fields, variables, and expressions for management of an object. In this example, an object management function is executed with a simple call to the RTOM engine 152 with a pointer to the desired MMO. Parameters 580 are maintained within the support objects. Instructions to access version history 570 (maintained along with the support objects) are also provided. To facilitate event-based query references, each MMO maintains a time stamp of the memory management execution. In one embodiment, the version reference query engine 144 can request details of MMOs from an object, whether stored as parameters alongside the elements of the object, or through references to the appropriate MMO. In an alternate embodiment, support for event information may be accessed through the RTOM engine 152. In any given embodiment, event-based version queries may utilize any method or system to determine the time of a supported event, the event or object referenced in the query reference requiring no relationship with the versioned data entity being accessed.

In the example embodiment, messages are treated as types which generate support objects rather than being treated as functions or built-in methods. This is for two reasons. First, as described above, messages can be composed without triggering their action, so objects can be created and modified by messages composed over multiple steps. Second, by treating them as types, constraints and errors, properties, and other elements associated to types can be associated to messages. Once stored, elements of the MMO are introduced and there needs to be a way to access an update or create, for example, so that the stored element can be retrieved and read from. In that sense embodying messages as objects of types is appropriate.

The object management functions, when successful, as described above, occur in at least two steps (even if combined in a single construct in source code). First, a message is encountered, and an associated support object is created. The message may be updated as necessary any number of times. Second, the data object is affected by the message when a trigger instruction is encountered. In these examples the trigger is simplified with an <-indicator and the messages are simplified for illustration.

The support object defined by the message will be deleted when it is no longer necessary to support its associated data object. The detail of interplay between message instructions, trigger instructions, and other support instructions, including version history, memory management, and persistence instructions is not shown. Those of skill in the art will readily adapt these teachings to suitable embodiments based on desired design parameters.

First, create message 802 is encountered, followed by a call to RTOM engine 152. A Create_of_Worker object 810 is constructed into memory. It contains initial values for the data elements 812 defined for a Worker object. It also contains any extensions for creating worker_object, such as parameters 814 and constraints 816. It is maintained in support object table 882.

Next, the trigger 803 for “sending” the create message is encountered. Create_of_Worker support object 810 includes all the information needed for RTOM engine 152 to create the object, worker_object 820, in concert with memory management system 850. A call to RTOM engine 152 with a link to support object 810 initiates the create process.

In this example, assume any constraint did not prevent the successful completion of the create function and so worker_object 820 is created. The initial values 812 for elements of data object worker_object stored in message 810 are instantiated as elements 822. Worker_object 820 exists, available in memory, and is maintained with object table 880. In addition, version history 890 has been updated with an entry 892a for the create of worker_object, using techniques such as those described above. The initial values of elements 812 and other historical data such as time are stored in create entry 892a.

Next, an update message 804 is encountered, followed by a call to RTOM engine 152. An Update_of_Worker object 830a is constructed into memory. It contains one or more element updates 832 and any extensions for updating worker_object 820, such as parameters 834 or constraints 836. It is maintained in support object table 882.

Subsequently, the trigger 805 for “sending” the update message is encountered. Update_of_Worker support object 830a includes all the information needed for RTOM engine 152 to update worker_object 820. A call to RTOM engine 152 with a link to support object 830 initiates the update process. Assuming any constraints are met, worker_object 820 has one or more elements 822 updated.

During the life cycle of an object, such as worker_object 820, multiple updates may be made. For each update message encountered at runtime, an Update_of_Worker object 830 is created, as illustrated by the sequence of objects 830a-830n. If and when each of the messages gets triggered (it is possible some do not), the respective objects 830 are used to update one or more elements 822 in worker_object 820.

Next, a delete message 806 is encountered, followed by a call to RTOM engine 152. A Delete_of_Worker object 840 is constructed into memory. It contains any extensions for deleting worker_object, such as parameters 842 or constraints 844. It is maintained in support object table 882. Until the message is triggered, it does not affect worker_object 820, e.g., it is not yet deleted. The only argument needed for a delete is the identity of the object to be deleted. If one or more parameters or constraints were defined for the delete of worker, those values would be added to the arguments for the message and stored in parameters 842 or constraints 844.

The effects of encountering trigger 807 for “sending” the delete message are not shown. Delete_of_Worker support object 840 includes all the information needed for RTOM engine 152 to delete worker_object 820. A call to RTOM engine 152 with a link to support object 840 would initiate the delete process when encountered, so long as all constraints are satisfied. If so, RTOM engine 152 will delete object 820. It will no longer exist in memory and is removed from object table 880.

For each of the create, update, and delete MMOs introduced in the previous example, the version history updater will make the appropriate entries in a version history, using techniques such as those detailed above. These details are omitted in FIG. 8. Here, the feature being illustrated is the ability for version reference query engine 144 to interface with any of the MMOs described. When a version query for an object is made, referencing one of these MMO events, the version reference query engine 144 can determine the time stamp for the event, and access from cache or rebuild from version history records the version of the requested data object. Again, the events, such as MMOs, do not have to be related to the data entity for which a version is being queried. The system provides the capability to determine the state of any of the versioned objects, if they exist, at the time of any runtime event, so long as the time of the event can be ascertained, as in this example embodiment.

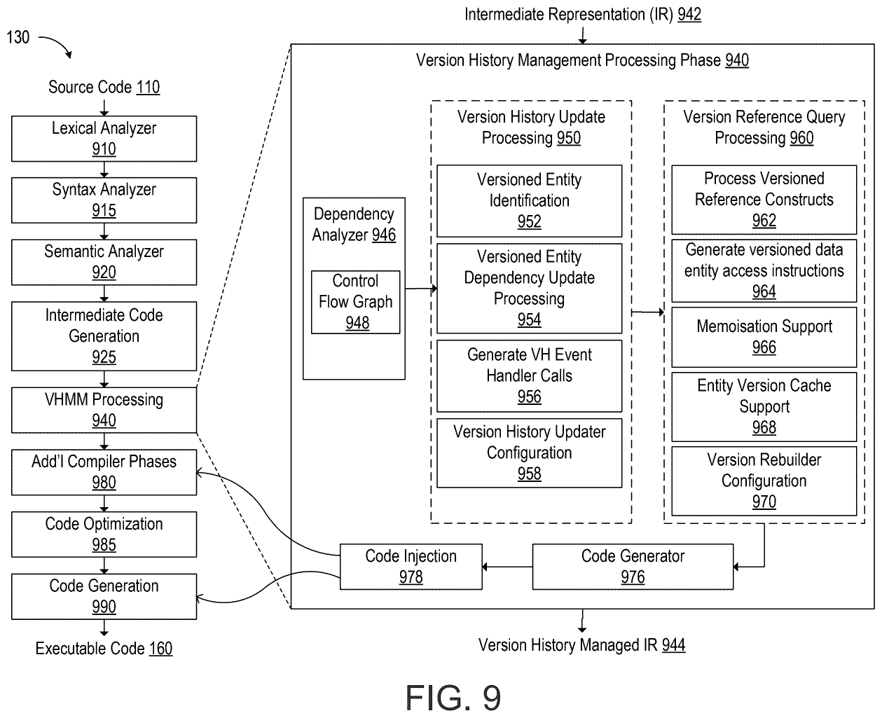

FIG. 9 is an example compiler 130 illustrating VHMM processing on an intermediate representation and an example version history management processing phase 940. Lexical analyzer 910 performs lexical analysis, also known as scanning, where source code is 110 is converted into a sequence of lexical units or tokens. Tokens are the smallest meaningful units of a programming language, such as keywords, identifiers, operators, and literals.

Syntax analyzer 915 performs syntax analysis, also known as parsing, where the compiler checks whether the sequence of tokens generated by the lexical analyzer 910 conforms to the rules defined by the programming language's grammar. This analysis typically involves constructing a parse tree or syntax tree (e.g. an AST) that represents the hierarchical structure of the source code.

Semantic analyzer 920 performs semantic analysis where the compiler examines the meaning of the statements and expressions in the source code beyond their syntactic structure. During semantic analysis, the compiler checks for semantic correctness, such as type compatibility, undeclared variables, and adherence to language-specific constraints. It also performs various optimizations and transformations based on the semantic properties of the code.

Intermediate code generation module 925 generates an intermediate representation (IR) 942 of the source code after semantic analysis and optimization, but before the final machine code. Often during intermediate code generation, the compiler translates high-level source code into an IR that is closer to the target machine language but still independent of the target machine architecture. This intermediate code is typically in the form of low-level instructions or an intermediate language. The main purpose of intermediate code generation is to provide a platform-independent representation of the source code that facilitates further optimization and simplifies the task of generating machine code for different target architectures. A variety of compiling processes may be applied to code in intermediate form. IR 942 may include one or more of any of a variety of forms, including but not necessarily a control flow graph, static single assignment, three-address code, intermediate representation language, an abstract syntax tree, and the like.

Code optimization module 985 is where the intermediate representation is improved to enhance its efficiency in terms of execution time, memory usage, or other performance metrics. During code optimization, the compiler applies various techniques and transformations to the intermediate code to eliminate redundant operations, minimize resource usage, and improve the overall quality of the generated code. Optimization techniques may include constant folding, dead code elimination, loop optimization, and many others. The primary goal of code optimization is to produce optimized code that executes more efficiently on the target platform, resulting in improved performance and reduced resource consumption. Other embodiments may employ different or additional compiler phases processing the IR for other purposes.

Code generation module 990 is where the optimized intermediate representation of the source code is translated into executable machine code specific to the target platform. During code generation, the compiler maps the instructions and constructs of the intermediate code to the corresponding machine instructions of and taking advantage of the specific features and optimizations offered by the target architecture. This involves generating assembly code or machine code that directly controls the behavior of the target hardware. Note that code generation may be carried out in multiple phases. For example, a low-level language such as c/llvm may be an intermediate target of code generation 990. An intermediate level compilation can be further processed into executable code 160 for one or more target processors and/or architectures.

In this embodiment, The VHMM processing phase 940 operates on IR 942 to produce version history managed IR 944, which is used in additional compiler phases 980 and leading to code optimization and code generation. The code that is generated can be compiled along with other code in the IR or can be injected into the executable during code generation 990, or a combination of both, as indicated in FIG. 9.

Version history update processing module 950 includes several illustrative sub-modules. Module 952 identifies each versioned entity. Utilizing dependency analyzer 946, including control flow graph 948, module 954 locates and processes the appropriate dependencies. Auto-generation of version history event handler calls occurs in module 956. Based on the types of versioned entities in the code being compiled module 958 configures the version history updater.

Version reference query processing module 960 includes several illustrative sub-modules. Module 962 locates and processes versioned reference constructs in the IR. Module 964 generates versioned data entity access instructions for each of the constructs. Memoisation support 966 and entity version cache support 968 provide memoising and caching, when supported, as described above. Based on the types of queries involved, module 970 configures the version rebuilder.

The code generator 976 takes in the generated instructions and converts some or all of them into a machine code format. Instructions can also be maintained in IR format. The code generator 976 ensures that machine code is optimized and compatible with the target system. This process can involve converting the instructions into binary code or bytecode, which is then translated into machine code. Instructions maintained in IR format can be further processed by the compiler.

The code injector 978 receives the generated machine code and inserts it into the appropriate location within the final executable during code generation 990. Instructions remaining in IR format are injected to IR for further processing in additional compiler phases 980, and any subsequent processing.

The description for compiler 130 support of VHMM is provided illustratively. Any number of other embodiments may be deployed where VHMM instructions are generated in any compiler phase or code format. It will be appreciated that it may be implemented in alternate ways over any of various phases and passes of compilation, using the principles described herein.

The version history update event handler 142 and its calls are injected into the user code. In various embodiments, the code may be introduced in one or more differing stages of compilation. The resultant compiled code will yield comparable expected performance results at runtime, but the compilation process itself may differ in performance depending on the embodiment. For example, in one embodiment, the handlers and calls can be generated as strings and inserted into the source code itself. In another embodiment, the handlers and calls can be generated in an intermediate representation format, such as AST nodes, and included in the AST for further compiling in the semantic analysis phase. In another embodiment, tree nodes equivalent to the event handlers are stitched to the root of the AST generated for the user code in the semantic analysis phase, and appropriate calls to these event handlers are introduced to the IR for inclusion in the final executable code during the code generation phase.

A compiler, examples of which are described above, is a program that translates source code instructions for performing computational functions into machine code that can be executed by a computer, alternatively referred to as binaries, executable code, execution code, application code, etc. Some languages are not compiled but are rather interpreted. Interpretation differs from compilation in that the interpreter executes programs directly from source code without producing a standalone executable. The prior discussion focuses on compilers, but those of skill in the art will recognize compiling source code to an executable that is run on a computer can be substituted with a process of interpreting the source code while running on an interpreter.

Source code is typically written in a high-level programming language, which is designed to be easy to read and understand by developers. Intermediate representations and machine code are written in more compact and efficient lower-level languages. An intermediate representation generated from one form of source code can itself be a form of source code. The methods detailed herein can be applied to original source code or various levels of source code derived therefrom. A keyword from one form of source code may be transformed to or represented by a different keyword, numerical value, or token when processed into another form of source code or intermediate representation. A reference to a particular keyword in the methods, systems and devices described herein applies equally to any transformation or alternate representation.

Program execution generally takes place on computer hardware in a runtime environment. The computer hardware comprises processors, memory, and storage. The runtime environment is a set of software tools and resources that runs on the computer hardware to execute a program. The runtime environment includes the operating system, libraries, and other components that are necessary for the program to run. Computer hardware and runtime environments are well known to those of skill in the art.

FIG. 10 illustrates an example embodiment of distributed IDE 1000 including components of a computational device, or user terminal, 100. Here user terminal 100 is connected via network 1040 with other user terminals 100a-n and a project server 1050. However, it should be noted that an IDE operating environment, a computational device 100, and the aspects disclosed herein are not constrained to any particular configuration of devices.

User terminals 100 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, an Internet-of-Things (IOT) device, a distributed computing system, multiprocessor systems, or combination thereof. A user terminal may be configured utilizing a cloud service. The operating environment of IDE 1000 may be configured in a network environment, a distributed environment, a multi-processor environment, or a stand-alone computing device having access to remote or local storage devices.

User terminals 100 may include one or more processors 1010, a communication interface 1012, one or more storage devices 1016, one or more input/output devices 1018, and a memory 150. A processor 1010 may be any commercially available or customized processor and may include multi-processor architectures. The communication interface 1012 facilitates wired or wireless communications between the computing devices such as user terminals 100, project server 1050, and other devices. The components of a user terminal 100 are communicatively coupled via one or more buses 1014.

A storage device 1016 may be a computer-readable medium that does not contain propagating signals, such as modulated data signals transmitted through a carrier wave. Examples of a storage device 1016 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1016 in the computing devices 100. The input/output devices 1018 may include a keyboard, mouse, pen, voice input device, touch input device, display, speakers, printers, etc., and any combination thereof.

A memory 150 may be any non-transitory computer-readable storage media that may store executable procedures, applications, and data. Various of these components and data are detailed above with respect to FIGS. 1A-C, 4, and 7-9. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc., A memory 150 may also include one or more external storage devices or remotely located storage devices.

The memory 150 may contain instructions, components, and data. A component is a software program that performs a specific function and is otherwise known as a module, program, and/or application. The memory 150 may include an operating system 1030, one or more source code files 110, a compiler 130, executable code 160, and other applications and data 1036. Compiler 130 may include a lexical analyzer 910, a syntax analyzer 915, a semantic analyzer 920, an intermediate code generation module 925, a code optimization module 985, a code generation module 185, a version history management module (VHMM) 120, an abstract syntax tree 180, and an intermediate representation 140.

Included in or alongside the executable code are the RTOM engine 152, version history updater 142, version reference query engine 144, version rebuilder 146, version history 190, and cache 194, detailed previously.

User terminal 100 may utilize an Integrated Development Environment (IDE) (details not shown) that allows a user (e.g., developer, programmer, designer, coder, etc.) to design, code, compile, test, run, edit, debug, or build a program, set of programs, web sites, web applications, and web services in a computer system. Software programs can include source code files 110, created in one or more source code languages (e.g., Visual Basic, Visual J #, C++. C#, J #, Java Script, APL, COBOL, Pascal, Eiffel, Haskell, ML, Oberon, Perl, Python, Scheme, Smalltalk and the like, as well as proprietary or custom-designed programming languages).

The IDE may provide a native code development environment or may provide a managed code development that runs on a virtual machine or may provide a combination thereof. The IDE may provide a managed code development environment using a framework such as Java SE, .NET, Node.js, Python Frameworks such as Django, Flask, etc., Ruby on Rails, PHP Frameworks such as Laravel, Symfony, etc., React, and others. It should be noted that this operating environment embodiment is not constrained to providing the source code development services through an IDE and that other tools may be utilized instead, such as a stand-alone source code editor and the like.

Project server 1050 may be any type of electronic device, including without limitation those detailed for user terminals 100. A project server may be configured utilizing a cloud service.

The user terminals 100 and project server 1050 may be communicatively coupled via network 1040. The network 1040 may be configured as an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Network (MAN), the Internet, a portion of the Public Switched Telephone Network (PSTN), Plain Old Telephone Service (POTS) network, a wireless network, a WiFi® network, or any other type of network or combination of networks.

The network 1040 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative and not limiting. Therefore, the spirit and scope of the appended claims should not be limited to the foregoing description. In U.S. applications, only those claims specifically reciting “means for” or “step for” should be construed in the manner required under 35 U.S.C. § 112 (f).

1. A method of compiling source code, the method comprising:
encountering in the source code an access instruction to a data entity, the access instruction including a version reference for identifying a version of the data entity;
generating first instructions to access a version history comprising records corresponding to one or more updates to the data entity, each record associated with an update time;
generating second instructions to select one or more of the records to form a version of the data entity, the selected updates having respective associated update times conforming with the version reference; and
generating third instructions to access the version of the data entity in accordance with the access instruction.

2. The method of claim 1, wherein the access instruction comprises an access construct modified by a versioned reference construct having the version reference.

3. The method of claim 1, further comprising:
evaluating the source code to determine a likelihood of runtime access to a version of the data entity; and
responsive to the likelihood exceeding a predetermined threshold:
generating fourth instructions to store in a memory a stored version of the data entity corresponding to the version of the data entity in a memory; and
generating fifth instructions to access the stored version of the data entity in accordance with the access instruction when the version reference equals the version, bypassing execution of the first, second, and third instructions.

4. The method of claim 2, wherein the access construct comprises one of an assignment construct, an argument to a function, and a parameter.

5. The method of claim 1, wherein an update to the data entity comprises one of a creation of the data entity, an update to a value of the data entity, appending an element to a collection within the data entity, removing an element from a collection within the data entity, and deletion of the data entity.

6. The method of claim 1, wherein the version reference is a version number.

7. The method of claim 1, wherein the version reference is a time.

8. The method of claim 1, wherein the version reference is an event.

9. The method of claim 1, wherein one or more records correspond to one or more modifications to the data entity, each modification comprising one of a modification to an element of the data entity, to an element of a container in the data entity, to a containment including the data element, and to a behavioral property dependent on the data entity.

10. A non-transitory computer-readable medium having stored thereon a source code compilable by a compiler and executable by a processor, the source code comprising:
a data entity definition defining a data entity;
one or more update instructions, each update instruction including an update construct to modify the data entity to a current version, wherein a plurality of runtime updates to the data entity via instructions compiled from each of the one or more update instructions produce one or more prior versions of the data entity;
an access construct for accessing the current version of the data entity; and
an access instruction including the access construct modified by a versioned reference construct having a version reference for identifying a prior version of the data entity, the data entity access instruction for accessing the one of the prior versions identified by the version reference.

11. The medium of claim 10, wherein the access construct comprises one of an assignment construct, an argument to a function, and a parameter.

12. The medium of claim 10, wherein the version reference is a version number.

13. The medium of claim 10, wherein the version reference is a time.

14. The medium of claim 10, wherein the version reference is an event comprising a memory management object event.

15. A method of compiling source code, the method comprising:
identifying a first data entity;
identifying a dependency of the first data entity;
encountering an update instruction to update the dependency providing an updated dependency;
generating instructions to:
capture a timestamp as the time at which the update instruction is executed at runtime; and
enter into a version history one or more records associated with the dependency, the one or more records each having the timestamp.

16. The method of claim 15, further comprising:
identifying a second dependency;
encountering a second update instruction to update the second dependency providing an updated second dependency; and
generating instructions to:
capture a timestamp as the time at which the second update instruction is executed at runtime; and
enter into a second version history one or more records associated with the dependency, the one or more records each having the timestamp.

17. The method of claim 16 wherein the first-mentioned version history and the second version history are separate.

18. The method of claim 16 wherein the first-mentioned version history and the second version history are the same version history.

19. The method of claim 15, wherein the dependency includes a data element, the update instruction assigns a value to the data element, and the generated instructions enter a first record associated with the data element in the version history containing the value.

20. The method of claim 19, wherein the dependency includes a container containing the data element, and the generated instructions enter a second record associated with the container in the version history containing an identifier of the data element.

21. The method of claim 20, wherein the container is an object and the data element is a first element of the object.

22. The method of claim 20, wherein the dependency includes a second data element, the container further contains the second data element, the update instruction further assigns a second value to the second data element, the generated instructions enter a third record associated with the second data element in the version history containing the second value, and the second record associated with the container further contains an identifier of the second data element.

23. The method of claim 15, wherein the dependency includes a container containing a collection of zero or more second data entities, the update instruction creates a third data entity and adds it to the collection, and the generated instructions enter a first record associated with the collection in the version history including an identifier of the third data entity and enter a second record associated with the third data entity in the version history including an indication of an element of the third data entity.

24. The method of claim 15, wherein the first data entity includes a computed entity dependent on the dependency and the generated instructions enter a record associated with the computed entity in the version history including an updated computed entity recomputed responsive to the update instruction.

25. The method of claim 24, wherein the computed entity is within a container and the dependency is in the container's containment; the method further comprising:
encountering an update to the dependency; and
generating instructions to enter one or more records in the version history associated with the dependency.

26. The method of claim 15, wherein the update instruction includes one of creating, updating, or deleting the first data entity.

27. The method of claim 15, wherein the data entity is identified responsive to encountering an access instruction including a version reference for identifying a prior version of the data element.

28. The method of claim 15, the method further comprising encountering in the source code a construct indicating a data entity designated for version history maintenance, wherein the first data entity is identified as the data entity indicated in the construct.

29. The method of claim 15, wherein the generated instructions comprise:
an event handler for entering records into the version history;
an event handler call to the event handler, the event handler call identifying the dependency and including the update dependency result and the timestamp.

30. A system comprising:
one or more processors coupled to a memory; and
one or more programs, wherein the one or more programs are stored in the memory and configured to be executed by the one or more processors, operable with source code having one or more data entities and one or more instructions performing a data modification on a data entity, the one or more programs including a compiler comprising:
a control flow graph generator configured to generate a control flow graph from the source code;
a dependency analyzer configured to analyze the control flow graph to identify dependencies among the one or more data entities;
a code generator to generate an event handler configured to store one or more records corresponding to a data modification performed on a first data entity and one or more records for each second data entity that depends on the first data entity, and wherein the code generator is further configured to generate one or more event handler calls to, responsive to the data modification, invoke the event handler to store the records; and
a code injector configured to insert the event handler into an intermediate representation of the source code, and wherein the code injector is further configured to insert the one or more calls to the event handler in the intermediate representation proximate to each instruction that performs the data modification for invoking the event handler at runtime.

31. The system of claim 30, wherein the dependencies include a container-containment relationship.

32. The system of claim 30, wherein the data modification includes one of create, update, or delete operations.

33-50. (canceled)
